(19) United States
(12) Patent Application Publication
(10) Pub. No.: US 2026/0358828 A1
(43) Pub. Date: Nov. 12, 2026

(54) INTERNAL PIPELINE WELDING MACHINE

(71) Applicant: CHENGDU XIONGGU JIASHI ELECTRICAL CO, LTD, Chengdu (CN)

(72) Inventors: Wenhu QIU, Chengdu (CN); Fei HUANG, Chengdu (CN); Minghong LUO, Chengdu (CN); Zhixiang ZOU, Chengdu (CN); Zhimei YANG, Chengdu (CN); Shuo LI, Chengdu (CN); Dejie ZHANG, Chengdu (CN)

(73) Assignee: CHENGDU XIONGGU JIASHI ELECTRICAL CO, LTD, Chengdu (CN)

(21) Appl. No.: 19/129,676

(22) PCT Filed: Aug. 3, 2023
(86) PCT No.: PCT/CN2023/110955

§ 371 Date: May 14, 2025

(30) Foreign Application Priority Data
Mar. 2, 2023 (CN) 202310194157.1

(51) Int. Cl. G05D 1/672; B23K 37/02; B60G 17/08; B60K 17/16; F16D 51/10; G05D 105/45; G05D 107/50

(52) U.S. Cl. CPC G05D 1/672; B23K 37/0223; B60G 17/08; B60K 17/16; F16D 51/10; G05D 2105/45; G05D 2107/50

(57) ABSTRACT

An internal pipeline welding machine includes a machine head, a machine body, and a first connecting mechanism. The machine head is provided with a tensioning mechanism and a welding mechanism, and the machine body is equipped with a traveling system for traveling inside the pipeline. The machine head is connected to the machine body via the first connecting mechanism, which has controllable degrees of freedom to allow relative deflection between the machine head and the machine body. In this internal pipeline welding machine, the machine head can deflect relative to the machine body, enabling the entire welding machine to bend accordingly. This design allows the welding machine to smoothly pass through curved pipeline sections, adapt to pipelines with different bending radii, effectively improve its cornering capability, and provide a wide range of applicability.

### CROSS REFERENCE TO THE RELATED APPLICATIONS

This application is the national phase entry of International Application No. PCT/CN2023/110955, filed on Aug. 3, 2023, which is based upon and claims priority to Chinese Patent Application No. 202310194157.1, filed on Mar. 2, 2023, the entire contents of which are incorporated herein by reference.

### TECHNICAL FIELD

The present invention relates to the technical field of welding equipment, and more particularly to an internal pipeline welding machine.

### BACKGROUND

Internal pipeline welding machines are widely used in pipeline construction in industries such as petrochemicals, electricity, coal, and water transmission. They are primarily used to align two pipeline sections and perform internal root welding. Pipelines laid in these industries often need to adapt to terrain and environmental conditions, which frequently result in slopes and curves. Especially in mountainous regions, pipelines often have steep slopes and small bending radii. The slope of a pipeline can exceed 25°, and in some local sections, it even exceeds 45°. The minimum bending radius can be as small as 6D (where D refers to the pipe's outer diameter). However, conventional internal pipeline welding machines have poor adaptability to terrain and passage ability, with limited climbing and cornering abilities. Due to their inherent length, they can only pass through pipe sections with large bending radii. When entering a pipe section with a smaller bending radius, the welding machine often becomes stuck and cannot pass through smoothly. This results in the inability to perform pipeline alignment or welding operations in curved sections, limiting its applicability.

### SUMMARY

The technical problem to be solved and the objective of the present invention is to improve the existing technology by providing an internal pipeline welding machine that addresses the problem of poor cornering ability of traditional machines and enables pipeline alignment and welding in curved sections.

To solve the above technical problem, the technical solution of the present invention is as follows:
An internal pipeline welding machine includes a machine head, a machine body, and a first connecting mechanism;
The machine head is equipped with a tensioning mechanism and a welding mechanism;
The machine body is equipped with a traveling system for moving within the pipeline;
The machine head is connected to the machine body via the first connecting mechanism, which has controllable degrees of freedom to allow relative deflection between the machine head and the machine body.

In this invention, the internal pipeline welding machine connects the machine head and the machine body through a deflectable first connecting mechanism, allowing the head to deflect relative to the body. This enables the machine to bend as a whole when passing through curved pipe sections. The deflection angle of the machine head is adjustable, allowing it to adapt to pipe sections with various bending radii, thereby ensuring smooth passage and avoiding blockage. This effectively improves the cornering ability of the welding machine and enhances its adaptability to different terrains.

Further, the first connecting mechanism includes a static end and a movable end. The static end is connected to the machine body, and the movable end is connected to the machine head. A plurality of movable members is arranged in parallel between the static and movable ends to enable relative movement between them. This invention adopts a parallel-structure movable end as the first connecting mechanism, allowing for multi-degree-of-freedom adjustments to meet the needs of navigating various curved pipe sections. The first connecting mechanism is an active adjustment structure, capable of actively adjusting the relative deflection between the static and movable ends by controlling the changes of the movable members. It can also stably maintain the deflected state, enabling precise adjustments according to the pipe's bending radius and direction, thereby allowing the machine to pass through curved sections more effectively.

Further, the movable members are linear telescopic components. One end of each telescopic component is movably connected to the static end, and the other end is connected to the movable end. This structure is simple and compact. The relative deflection between the static and movable ends can be controlled by adjusting the extension of each linear component, which is easy to control and provides high precision.

Further, the first connecting mechanism is a parallel or serial motion mechanism, with two and six degrees of freedom. This high flexibility allows for deflection and even translation of the machine head relative to the body, facilitating flexible and accurate adjustment of the head's posture, thus enhancing the welding machine's maneuverability.

Further, a sensor for detecting the pipeline is installed on the machine head. The control system receives and analyzes the data collected by the sensor to generate control parameters. The first connecting mechanism then acts according to these parameters to adjust the position and posture of the machine head. By using sensors to detect the condition of the pipeline, the position and posture of the machine head relative to the pipeline can be determined. The first connecting mechanism then adjusts the position and posture of the machine head accordingly, enabling precise posture adjustments for cornering or welding operations. This enhances the level of automation, allowing the internal pipeline welding machine to automatically adjust its posture according to the specific conditions of the pipeline. As a result, the tensioning mechanism and welding mechanism on the machine head can be precisely aligned with the weld seam area at the pipe ends, thereby improving the welding quality.

Further, multiple sensors are circumferentially disposed on the machine head at intervals, and the central axis of the circle on which the sensors are located coincides with the central axis of the tensioning mechanism. By detecting the pipeline from multiple circumferential positions through these sensors and comprehensively analyzing the data they collect, the position and posture of the tensioning mechanism and welding mechanism relative to the pipeline can be identified with higher precision. This allows for more accurate adjustment of the machine head's posture so that the tensioning mechanism and welding mechanism are precisely aligned with the pipeline, thereby improving the welding precision and quality.

Further, the sensors are stripe-type laser displacement sensors which are used to detect and collect pipeline profile data. These stripe-type laser displacement sensors emit line-shaped laser stripes that are projected onto the pipeline, specifically onto the inner wall and the groove at the pipe end, thereby forming a laser profile line on the pipeline. The sensor-detected laser profile line image represents the pipeline profile data. Differences in the machine head's position and posture relative to the pipeline result in different laser profile line images. By analyzing these images, the current position and posture of the machine head relative to the pipeline can be determined, enabling the first connecting mechanism to adjust the machine head to the most accurate posture.

Further, the control system includes a coaxial unit configured to analyze and process the data collected by the sensors to obtain control parameters for coaxial alignment. The first connecting mechanism operates based on these control parameters to align the central axis of the welding mechanism on the machine head with the central axis of the pipeline at the welding location. Based on the sensor data, the first connecting mechanism automatically controls the posture of the machine head, maintaining alignment between the welding mechanism's axis and the pipeline's axis to achieve coaxial cornering. As the pipeline's axis bends and deflects through curved pipe sections, the machine head must simultaneously deflect to maintain coaxial alignment of the central axis of the welding mechanism with that of the pipeline. The first connecting mechanism operates in real time according to the sensor data to deflect the machine head accordingly, ensuring that the welding mechanism remains coaxial with the pipeline. This enables the internal welding machine to automatically adjust the deflection posture of the machine head relative to the machine body when passing through curved pipe sections, allowing the machine to form a bent configuration and smoothly traverse the curve, thereby enhancing its cornering capability.

Further, the control system includes an alignment unit configured to analyze and process the data collected by the sensors to generate control parameters for alignment. The first connecting mechanism then operates according to the alignment control parameters to align the welding mechanism with the center of the weld seam between the two pipeline sections to be joined. Based on the data from the sensor, the first connecting mechanism adjusts the machine head's posture to achieve automatic alignment. Owing to its high operational precision, the first connecting mechanism improves both the accuracy and the efficiency of alignment.

Further, the alignment unit includes the following modules:
a scene determination module, configured to analyze and process the sensor data to determine whether the pipe end alignment scene is present;
a measurement module, which, upon detection of an alignment scene, analyzes the sensor data to determine the distance from the sensor to the plane at the pipe end;
a parking module, configured to issue a command to the traveling system to stop the machine body when the distance from the sensor to the pipe end plane reaches a defined parking condition;
a fine alignment module, which, while the machine body is in a stationary state, analyzes the sensor data to obtain control parameters for fine adjustment. The first connecting mechanism then operates based on these parameters to align the welding mechanism precisely with the center of the weld seam between the two pipe sections.

When welding two pipeline sections together, to ensure welding quality, the welding torch of the welding unit is required to be precisely aligned with the center of the weld seam between the two pipes. Given the relatively low positioning accuracy of the traveling system on the machine body, it is difficult to rely solely on the traveling system's parking position to achieve precise alignment of the welding mechanism with the center of the weld seam. Since the first connecting mechanism offers high positioning accuracy, when the sensors detect the pipe end, the traveling system is first controlled to stop the internal pipeline welding machine near the weld seam. Specifically, the parking position of the traveling system is determined by detecting the distance from the sensor to the plane at the pipe end. Then, while the machine body remains stationary, the posture of the machine head is finely adjusted by the first connecting mechanism to align the welding mechanism precisely with the center of the weld seam. This process is highly automated, requires no manual intervention, and offers high alignment accuracy and efficiency, thereby effectively improving the quality of the welded connection.

Further, the traveling system includes a traveling mechanism, which includes a plurality of traveling wheel assemblies circumferentially spaced around the machine body. These traveling wheel assemblies are connected to a tensioning mechanism arranged on the machine body. This configuration is simple and easy to implement. The traveling mechanism is primarily used to drive the machine body along the inner wall of the pipeline. The traveling wheel assemblies are pressed against the inner wall of the pipeline by the tensioning mechanism, ensuring that the traveling components can stably propel the internal pipeline welding machine forward. This improves the climbing capability of the machine, prevents slipping or rollback, and enables reliable operation in steeply inclined pipeline sections.

Further, two traveling wheel assemblies are arranged on the opposite sides of the machine body along its diameter, and the tensioning mechanism is a tensioning hydraulic cylinder connected between the two traveling wheel assemblies. This design is compact and simple in structure. The spacing between the two wheel assemblies is adjusted via the hydraulic cylinder, which presses the wheels firmly against the inner wall of the pipe. The use of hydraulic pressure provides a strong tensioning force without increasing the size of the system, thereby enhancing the stability of the welding machine as it travels along the pipeline.

Further, each traveling wheel assembly is equipped with a respective drive motor, enabling independent operation and control of each wheel assembly. The rotational speed of each traveling wheel assembly can be flexibly adjusted as needed. In particular, when navigating a curved section, electronic differential control is applied, i.e., the wheel assembly on the inner side of the curve moves at a lower speed than the wheel assembly on the outer side. This improves cornering reliability, prevents the welding machine from becoming stuck in curved sections, and avoids excessive load on the drive motors that could lead to damage.

Further, the traveling system includes a brake mechanism which includes a brake cylinder, brake pads, and a retaining elastic component. The brake pads are actuated by the brake cylinder to switch between braking and release positions. The brake pads are also connected to the retaining elastic component, which holds the brake pads in the braking position. This design improves braking reliability. Even if the brake cylinder fails, the brake pads can still remain pressed against the inner wall of the pipeline under the force of the elastic component, preventing rollback and allowing the internal welding machine to remain securely stationary on steep pipe sections, thus improving safety and reliability.

Further, the traveling system includes a flexible wheel assembly which includes a wheel, a wheel seat, and an elastic component. The wheel is mounted on the wheel seat, which is hinged to the machine body. The rotation plane of the wheel seat is oriented radially relative to the machine body, and the elastic component is connected between the wheel seat and the machine body. The wheel in the flexible wheel assembly can move radially relative to the machine body to provide buffering and shock absorption. When the welding machine is subjected to external forces, e.g. when the tensioning mechanism presses against the inner pipe wall or when the machine head collides with the pipe wall, the wheel and wheel seat deflect relative to the machine body, causing elastic deformation of the elastic component. This configuration absorbs impact forces and effectively protects the welding machine from damage.

Further, the flexible wheel assembly also includes an angle adjustment motor mounted on the wheel seat and connected to the wheel, which adjusts the traveling direction of the wheel. During operation, the internal welding machine may rotate relative to the pipeline due to variations in posture. The angle adjustment motor adjusts the wheel direction to allow the welding machine to rotate relative to the pipeline and restore the desired posture.

Further, the system includes a battery unit configured to supply power to the tensioning mechanism, welding mechanism, traveling system, and the first connecting mechanism. This integrated design enables centralized power supply via the battery unit, making the internal pipeline welding machine more flexible in application.

Further, the machine body is divided into multiple segments along the axial direction of the pipeline, and adjacent segments are connected by a second connecting mechanism, which is a deflectable connection. Dividing the machine body into multiple segments allows relative deflection between adjacent sections through the second connecting mechanism. As a result, the machine body can bend and deform to pass through pipe sections with smaller bending radii, thereby further enhancing the cornering capability of the welding machine.

Further, the second connecting mechanism includes a first end, a second end, a universal joint, and flexible connecting components. The universal joint and flexible connecting components are connected between the first and the second ends, with multiple flexible members distributed circumferentially around the universal joint. The first end connects to the preceding segment, while the second end connects to the following segment. This structure is simple and easy to implement. The second connecting mechanism is a passive deflectable connection, which does not require active adjustment. When the internal welding machine travels through a curved section, each segment of the machine body comes into contact with the inner wall of the pipeline. Under the action of contact force from the pipe wall, the adjacent segments deflect relative to one another through the second connecting mechanism to match the bending radius of the curved section. This allows the machine body to passively form a curved shape corresponding to the pipe bend, enabling the internal welding machine to smoothly traverse the curved section.

In the prior art, to enhance the maneuverability of internal welding machines within pipelines, the machine is typically segmented and connected via universal joints to improve its cornering ability. However, due to the influence of the inner circumferential surface of the pipeline, the machine often experiences helical rotation during operation, which alters the initial welding position of the welding head on the welding assembly. This affects the weld overlap quality and construction efficiency. Typically, the posture should be adjusted manually and without quantitative feedback, to result in low controllability and poor operational efficiency.

The present invention provides a posture adjustment system for an internal welding machine, including a posture adjustment device, sensors, and an electrical control module. The posture adjustment device is disposed between the first segment and the second segment of the internal welding machine.

The posture adjustment device includes a movable platform, a fixed platform, and linear actuators. The movable platform is connected to the first segment, the fixed platform is connected to the second segment, and both ends of each linear actuator are movably connected to the movable and fixed platforms, respectively.

The sensors are configured to acquire pipeline profile data around the movable platform of the first segment.

The linear actuators are connected to the electrical control module, which calculates the target posture of the first segment based on the profile data and adjusts the linear actuators accordingly to align the axis of the movable platform with the target posture.

Further, the posture adjustment device includes a movable-end mounting base and a fixed-end mounting base.

The movable-end mounting base is mounted to the movable platform via bolts, and one end of each linear actuator is detachably connected to the movable-end mounting base via a universal joint.

The fixed-end mounting base is mounted to the fixed platform via bolts, and the other end of each linear actuator is detachably connected to the fixed-end mounting base via a universal joint.

Further, the posture adjustment device is a six-degree-of-freedom motion platform composed of six linear actuators.

Further, multiple sensors are used and are uniformly distributed circumferentially around the first segment.

Further, the sensors are stripe-type laser sensors configured to acquire laser profile lines projected onto the inner circumferential surface of the pipeline, thereby obtaining the pipeline profile data around the tensioning unit of the first segment.

Further, the electrical control module includes:
a motion controller, configured to calculate the target posture of the first segment based on the pipeline profile data and to generate corresponding actuator length variation signals using inverse kinematics algorithms;
a servo driver, configured to generate corresponding pulse signals based on the actuator length signals from the motion controller;
a servo motor, configured to rotate according to the pulse signals from the servo driver to drive the corresponding linear actuator to extend or retract until the first segment reaches the target posture.

A posture adjustment method for an internal welding machine based on the above system, used to adjust the positional relationship between the first and second segments of the internal welding machine, including:
acquiring pipeline profile data around the movable platform of the first segment; calculating the target posture of the first segment based on the profile data, and generating adjustment signals based on the target posture;
driving the linear actuators based on the adjustment signals so that the axis of the movable platform on the first segment reaches the target posture.

Further, the step of calculating the target posture of the first segment and generating adjustment signals based on the profile data specifically includes:
converting the profile data obtained by each sensor into corrected profile data in the coordinate system of the first segment, based on known sensor installation correction coefficients; calculating the current position and posture information of the pipeline in the coordinate system of the first segment based on the corrected profile data;
deriving the target posture of the first segment from the pipeline position and posture information and generating adjustment signals based on the target posture.

The present application also provides a storage medium storing a computer program, wherein the computer program, when executed, performs the steps of the aforementioned posture adjustment method for the internal welding machine.

The present application also provides an internal welding machine including: a first segment, a second segment, and the posture adjustment system.

The posture adjustment system includes a posture adjustment device, an electrical control module, and sensors.

The posture adjustment device is disposed between the first segment and the second segment of the internal welding machine. The posture adjustment device includes a movable platform, a fixed platform, linear actuators, and universal joints. The movable platform is integrally formed with the frame of the first segment, and the fixed platform is integrally formed with the frame of the second segment. Both ends of each linear actuator are respectively connected to the movable platform and fixed platform via universal joints.

The sensors are configured to acquire pipeline profile data around the movable platform of the first segment.

The electrical control module is configured to calculate the target posture of the first segment based on the pipeline profile data and to derive actuator length variation signals by performing inverse kinematics calculations on the target posture. The electrical control module further drives the linear actuators to extend or retract based on the length variation signals so as to position the first segment in the target posture.

The present application provides a posture adjustment system for an internal welding machine, including a first segment, a second segment, and a posture adjustment device arranged between the two segments. The posture adjustment device includes a movable platform, a fixed platform, linear actuators, and universal joints. The movable platform is integrated with the frame of the first segment, and the fixed platform is integrated with the frame of the second segment. The linear actuators are connected to the moving and fixed platforms via universal joints at both ends. Sensors are configured to acquire pipeline profile data at the location of the movable platform. The electrical control module calculates the target posture of the first segment based on the pipeline profile data, performs inverse kinematics calculations to generate length variation signals for the linear actuators, and controls the actuators to extend or retract accordingly so that the first segment reaches the target posture.

The posture adjustment device of the present application is positioned between the first and second segments of the internal welding machine and includes a movable platform, a fixed platform, linear actuators, and universal joints. Because the movable platform is integrally formed with the frame of the first segment, and the fixed platform is integrally formed with the frame of the second segment, the extension and retraction of the linear actuators enable posture adjustment of the first segment. The electrical control module calculates the target posture of the first segment based on the pipeline profile data and derives the required actuator length variations through inverse kinematics. The actuators are then driven according to the length variation signals to achieve the desired posture of the first segment. This solution allows for automatic adjustment of the internal welding machine's posture based on pipeline profile data, thereby improving welding quality. The application also provides a posture adjustment method, a storage medium, and an internal welding machine that achieve the above-mentioned beneficial effects.

When the internal welding machine is used for welding operations in curved pipeline sections, changes in pipeline shape may result in significant deviation between the welding position and the groove at the pipe end, leading to low alignment accuracy. Manual adjustment by personnel is often required. Given the considerable weight of the internal welding machine, manual adjustment is time-consuming and inconvenient.

The present application provides an alignment method for internal welding machines, including the following steps:
detect pipeline profile data around the welding unit of the internal welding machine, and determine whether the pipe end is detected based on the profile data;
control the drive mechanism of the internal welding machine to stop axial movement when the distance between the sensor and the pipe end plane satisfies a preset threshold;
calculate the positional relationship between the sensor and the pipe end to obtain position and posture information, and adjust a multi-degree-of-freedom mechanism between the welding cone assembly and the body of the machine based on the position and posture information so that the welding unit is aligned with the groove and the internal welding machine is fixed relative to the pipeline.

Further, the step of detecting pipeline profile data around the welding unit includes:
acquiring pipeline profile data through sensors mounted on the welding cone assembly;
binarizing the profile data to generate a profile line image and comparing it with a preset groove profile line image;
determining whether the pipe end has been detected based on the comparison result.

Further, the sensor is a stripe-type laser displacement sensor used to scan line-shaped laser beams and obtain pipeline profile data that include data from the inner circumferential surface or the pipe end.

Further, the step of controlling the drive mechanism to stop the internal welding machine in axial movement along the pipeline when the distance between the sensor and the pipe end plane meets a preset threshold includes:

When the pipe end is detected and the matching result exceeds 1,

the positional relationship between the sensor and the plane where the pipe end is located is calculated to determine whether it meets a preset distance condition. If the condition is satisfied, the drive mechanism of the internal welding machine is controlled to stop axial movement so that the welding unit is positioned within the groove region.

Further, before the step of stopping axial movement of the internal welding machine, the following steps are included:
processing the pipeline profile data to obtain coarse translation and coarse rotation values of the pipeline profile relative to the cone assembly;
adjusting the multi-degree-of-freedom platform to make the central axis of the welding unit coaxial with that of the surrounding pipe section.

Further, the step of calculating the positional relationship between the sensor and the pipe end to obtain position and posture includes:
acquiring pipeline profile data to generate a profile line image and performing corner detection to obtain coarse coordinate values of profile vertices;
using the coarse coordinates of the profile vertices as initial values, performing groove profile fitting to obtain precise coordinates of the profile vertices;
converting the precise vertex coordinates into groove feature spatial coordinates in the coordinate system of the cone assembly;
calculating the position and posture of the current groove circle in the coordinate system of the cone assembly based on the groove feature points;
obtaining position and posture information, including angular deviation and offset between the groove and the cone assembly.

Further, the groove profile fitting to obtain precise vertex coordinates based on the profile data includes:
constructing a mathematical model of the groove profile using the corner point coordinates as initial values;
solving the groove model using a least squares optimization function to derive precise vertex coordinates.

Further, the step of adjusting the multi-degree-of-freedom mechanism between the cone assembly and the machine body based on position and posture information to align the welding unit with the groove and fix the machine relative to the pipe includes:

adjusting the multi-degree-of-freedom mechanism between the cone assembly and the machine body based on position and posture information and regulating the extension and retraction of one or more electric actuators in the multi-degree-of-freedom mechanism, so that the welding torch in the welding unit on the cone assembly is precisely aligned with the groove;

After posture adjustment of the cone assembly is completed, extending the tensioning mechanism to fix the internal welding machine relative to the pipe.

The present application further provides an alignment device for an internal welding machine, including tensioning units arranged circumferentially around the machine head, and further including:
A sensor for detecting pipeline profile data around the welding unit of the internal welding machine and determining whether a pipe end is detected based on the profile data;
a control system configured to control the drive mechanism to stop the internal welding machine's axial movement along the pipeline when the distance between the sensor and the pipe end plane meets a preset threshold;
The control system is also configured to calculate position and posture information based on the positional relationship between the sensor and the pipe end, and adjust a multi-degree-of-freedom mechanism between the cone assembly and the machine body to align the welding unit on the cone assembly with the groove, and fix the internal welding machine relative to the pipeline.

The present application also provides an internal welding machine including: a cone assembly, a machine body, a sensor, a multi-degree-of-freedom adjustment mechanism, a memory, and a processor. The sensor is disposed on the cone assembly, and the multi-degree-of-freedom adjustment mechanism is disposed between the cone assembly and the machine body. The memory stores a computer program which, when executed by the processor, performs the above alignment method for the internal welding machine.

The present application further provides a storage medium on which a computer program is stored. When executed, the program performs the steps of the internal welding machine alignment method as described above.

The present application provides an alignment method for an internal welding machine, wherein the machine includes a sensor disposed on the cone assembly and a multi-degree-of-freedom adjustment mechanism disposed between the cone assembly and the machine body. The alignment method includes: acquiring pipeline profile data via the sensor; determining a target stop position based on the profile data and controlling the internal welding machine to move to the target stop position; when the internal welding machine reaches the target stop position, the welding unit in the cone assembly moves to the groove region; determining groove feature points based on the profile data, and determining groove position and posture information in the coordinate system of the cone assembly according to the groove feature points; adjusting the position and posture of the cone assembly based on the groove position and posture information using the multi-degree-of-freedom adjustment mechanism to align the welding torch in the welding unit with the center of the weld seam of the pipe groove; performing alignment operations at the groove location.

The present application adjusts the position and posture of the cone assembly using the multi-degree-of-freedom mechanism based on the groove position and posture information, so that the welding torch of the welding unit is precisely aligned with the center of the weld seam. Through the above method, the welding torch of the welding unit in the internal welding machine can be automatically adjusted to align precisely with the weld seam center of the pipe groove in an alignment scenario, thereby achieving high-precision automated alignment and improving welding quality. The present application also provides an internal welding machine alignment device, a storage medium, and an internal welding machine, all of which offer the aforementioned beneficial effects and are not described in detail herein.

Compared with the prior art, the advantages of the present invention are as follows:
In the internal pipeline welding machine of the present invention, the machine head can deflect relative to the machine body, causing the entire welding machine to undergo a bending configuration change. This enables the internal welding machine to smoothly traverse curved sections of the pipeline, adapt to bends with varying radii, effectively enhance its cornering capability, and flexibly meet the demands of different terrains;
The first connecting mechanism is an actively adjustable structure, which allows for active posture adjustment of the machine head relative to the body, ensuring smoother and unobstructed navigation through bends; The system offers a high degree of automation, eliminating the need for manual intervention.
It can automatically adjust the machine's posture based on pipeline conditions to achieve automatic cornering and alignment. The welding mechanism can be accurately aligned with the weld seam center, ensuring high alignment efficiency, high precision, and improved welding quality.

### BRIEF DESCRIPTION OF THE DRAWINGS

FIG. 1 is a schematic view of the overall structure of an internal pipeline welding machine according to the present invention;

FIG. 2 is a top view of the structure shown in FIG. 1;

FIG. 3 is a schematic diagram showing the structure in which the tensioning mechanism and welding mechanism are installed on the machine head;

FIG. 4 is a structural view of the welding unit;

FIG. 5 is a schematic diagram of the tensioning and welding mechanisms on the machine head in cooperation with two pipe sections to be joined;

FIG. 6 is a schematic diagram of one structural embodiment of the first connecting mechanism;

FIG. 7 is a schematic diagram of another embodiment of the first connecting mechanism;

FIG. 8 is a schematic view of one embodiment of the movable member;

FIG. 9 is an end view of the machine head;

FIG. 10 is a schematic view of a laser profile line formed by a stripe laser projected onto the pipeline by a sensor;

FIG. 11 is schematic view of another laser profile line formed by the stripe laser projected onto the pipeline by the sensor;

FIG. 12 is a further schematic view showing another laser profile line formed by the stripe laser projected onto the pipeline by the sensor;

FIG. 13 is a schematic view of the traveling mechanism;

FIG. 14 is a schematic view of the brake mechanism;

FIG. 15 is a schematic view of the flexible wheel assembly;

FIG. 16 is a schematic view of the hydraulic system;

FIG. 17 is a schematic view of another internal pipeline welding machine according to the present invention;

FIG. 18 is a schematic view of an integrated intelligent internal pipeline welding machine provided in an embodiment of the present application;

FIG. 19 is a schematic view of a posture adjustment system provided in an embodiment of the present application;

FIG. 20 is a structural schematic view of the posture adjustment device provided in an embodiment of the present application;

FIG. 21 is a flowchart of a posture adjustment method for an internal welding machine provided in an embodiment of the present application;

FIG. 22 is a schematic view of an internal welding machine traversing a bent pipe section provided in an embodiment of the present application;

FIG. 23 is an overall schematic diagram of a control system provided in an embodiment of the present application;

FIG. 24 is a flowchart of an alignment method for an internal welding machine provided in an embodiment of the present application;

FIG. 25 is a schematic view of the structure of an internal welding machine provided in an embodiment of the present application;

FIG. 26 is a partially enlarged view of the welding unit and the groove during the alignment process provided in an embodiment of the present application;

FIG. 27 is a schematic view showing downsampled image conversion of groove profile data acquired by a sensor provided in an embodiment of the present application;

FIG. 28 is a schematic view showing the result of corner point detection on groove profile data provided in an embodiment of the present application;

FIG. 29 is a schematic view showing the fitting result of a groove profile provided in an embodiment of the present application.

In the figures:
machine head 1; machine body 2; first connecting mechanism 3; static end 31; movable end 32; movable member 33; oblique slide rail 331; slider 332; drive mechanism 333; actuator rod 334; tensioning mechanism 11; front tensioning assembly 111; rear tensioning assembly 112; welding mechanism 12; welding unit 121; sensor 4; traveling mechanism 51; traveling wheel assembly 511; pressing mechanism 512; traveling motor 513; brake mechanism 52; brake cylinder 521; brake pad 522; elastic retaining member 523; flexible wheel assembly 53; wheel 531; wheel seat 532; elastic member 533; angle adjustment motor 534; rear wheel 54; battery unit 6; welding power source 7; hydraulic system 8; front tensioning cylinder 81; rear tensioning cylinder 82; traveling cylinder 83; shielding gas cylinder 9; second connecting mechanism 10;
first end 101; second end 102; universal joint 103; flexible connecting component 104; first segment 201; welding device 202; tensioning assembly 203; posture adjustment device 204; second segment 205; movable platform 2041; linear actuator 2042; fixed platform 2043; movable-end mounting seat 2044; fixed-end mounting base 2045;
cone assembly 301; multi-degree-of-freedom adjustment mechanism 303; welding unit 304; expansion boot 305; tensioning device 306; body mechanism 302; traveling device 308; braking device 309; flexible front wheel 3010; fixed steel pipe 3011; groove region 3012.

### DETAILED DESCRIPTION OF THE EMBODIMENTS

The following clearly and completely describes the technical solutions of the embodiments of the present invention with reference to the accompanying drawings. It should be understood that the described embodiments are only some of the embodiments of the invention and are far more exhaustive. Based on the embodiments of the present invention, all other embodiments obtained by those skilled in the art without creative efforts shall fall within the scope of protection of the present invention.

The embodiment of the present invention discloses an internal pipeline welding machine, which effectively improves its cornering ability and passage performance. The system features good posture adjustment controllability and high precision, allowing accurate and efficient pipeline alignment and welding.

### Embodiment 1

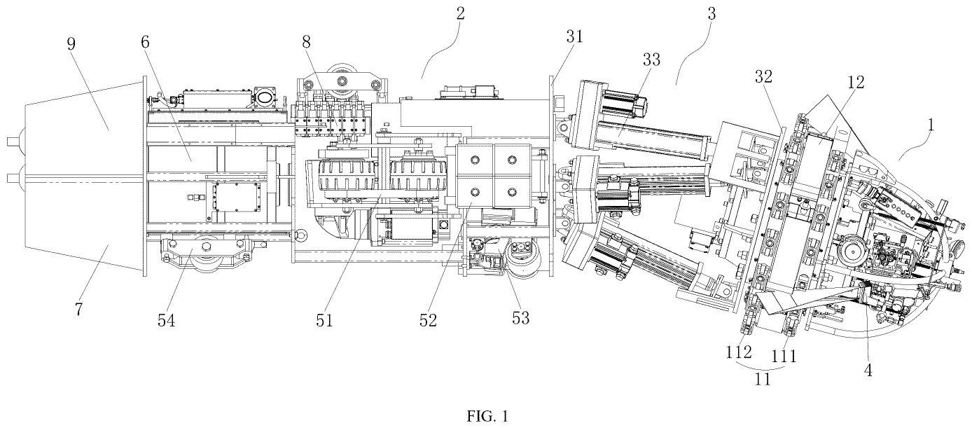

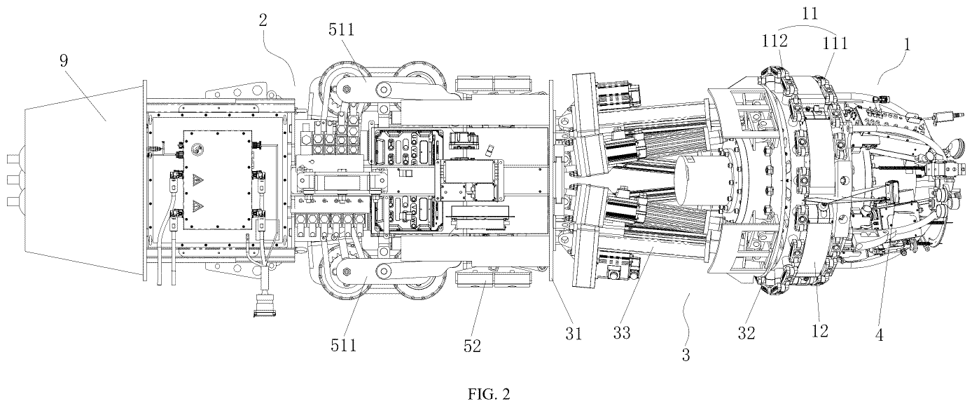

As shown in FIGS. 1-2, an internal pipeline welding machine mainly includes a machine head 1, a machine body 2, and a first connecting mechanism 3.

The machine head 1 is provided with a tensioning mechanism 11 and a welding mechanism 12.

The machine body 2 is provided with a traveling system for movement inside the pipeline.

The machine head 1 is connected to the machine body 2 via the first connecting mechanism 3, which has controllable degrees of freedom allowing relative deflection between the machine head 1 and the machine body 2.

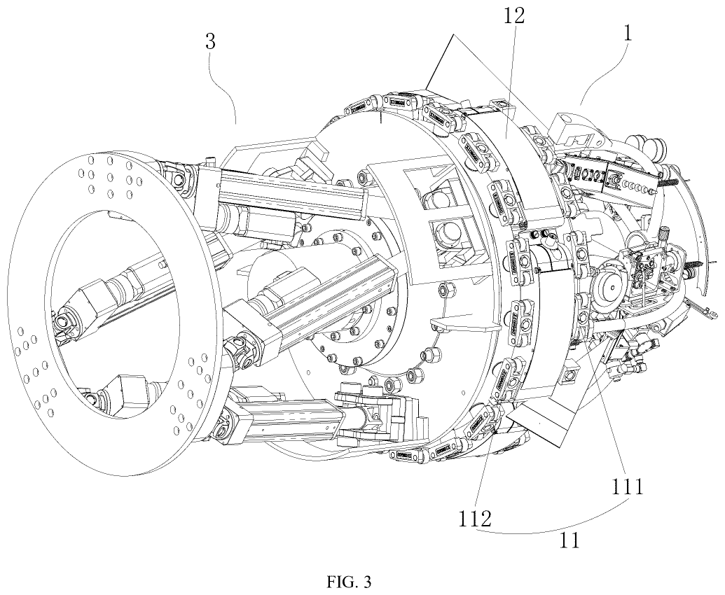

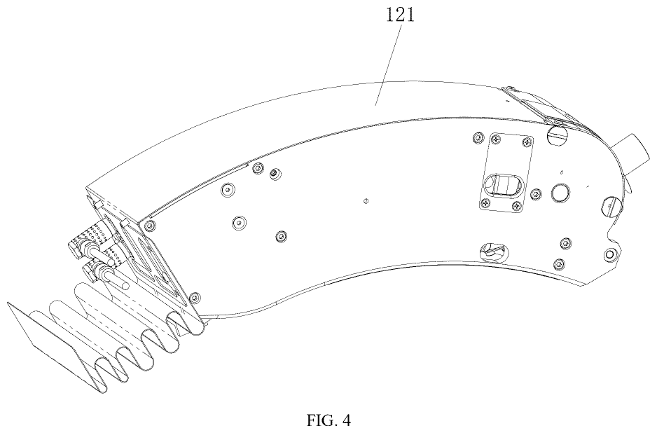

As shown in FIGS. 1-3, the tensioning mechanism 11 includes a front tensioning assembly 111 and a rear tensioning assembly 112 spaced along the axial direction of the pipeline. The welding mechanism 12 is positioned between the front and rear tensioning assemblies 111 and 112. Both the front and rear tensioning assemblies 111 and 112 include several tensioning units distributed circumferentially. The welding mechanism 12 includes several welding units 121 also distributed circumferentially. The tensioning mechanism 11 and the welding mechanism 12 share a common central axis, that is, the circular distribution of the tensioning units is coaxial with that of the welding units. As shown in FIG. 4, the welding unit 121 is an execution component that includes elements such as a wire reel, a wire feeder, and a welding torch. It performs welding operations on the annular gap between the grooved ends of two pipe sections, welding their inner grooves into a single unit.

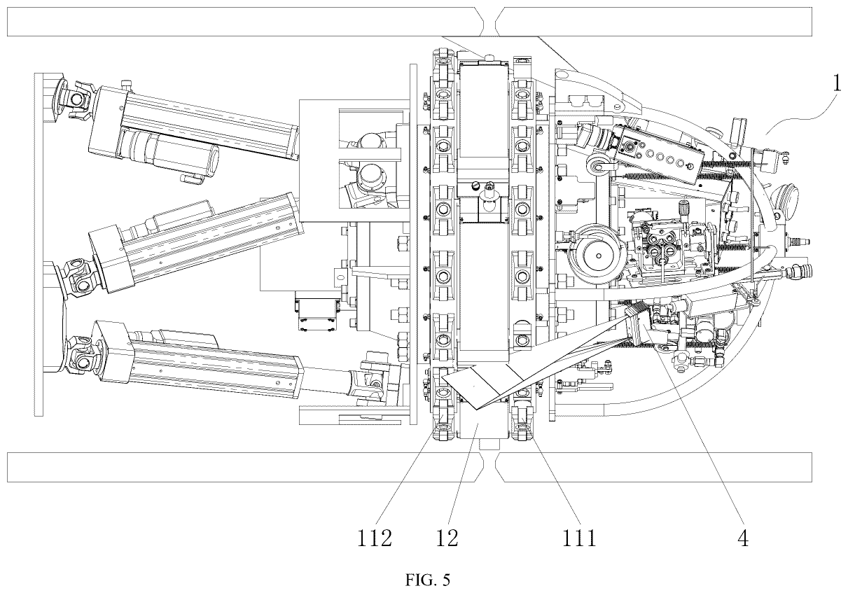

The machine body 2 moves along the interior of a fixed pipeline via the traveling system, carrying the machine head 1 with it. Eventually, the machine head 1 is moved to the position between the two pipe sections to be joined, specifically to the location of the weld seam. As shown in FIG. 5, the welding torches of the welding units of the welding mechanism 12 on the machine head 1 are aligned with the center of the weld seam between the pipe end grooves (the weld seam refers to the unwelded annular gap between the two pipe end grooves to be joined). The front and rear tensioning assemblies 111 and 112 are located on the opposite axial sides of the welding mechanism 12 and are respectively positioned inside the two pipe sections to be joined. The front tensioning assembly 111 and the rear tensioning assembly 112 expand radially outward to press tightly against the inner walls of the respective pipe sections, thereby fixing each pipe section to the front and rear tensioning assemblies 111 and 112, respectively. This configuration ensures that the weld seam between the two pipe sections remains in a fixed position, while the welding mechanism 12 remains precisely aligned with the center of the weld seam. As a result, stable and accurate welding operations can be carried out, thereby improving the welding quality.

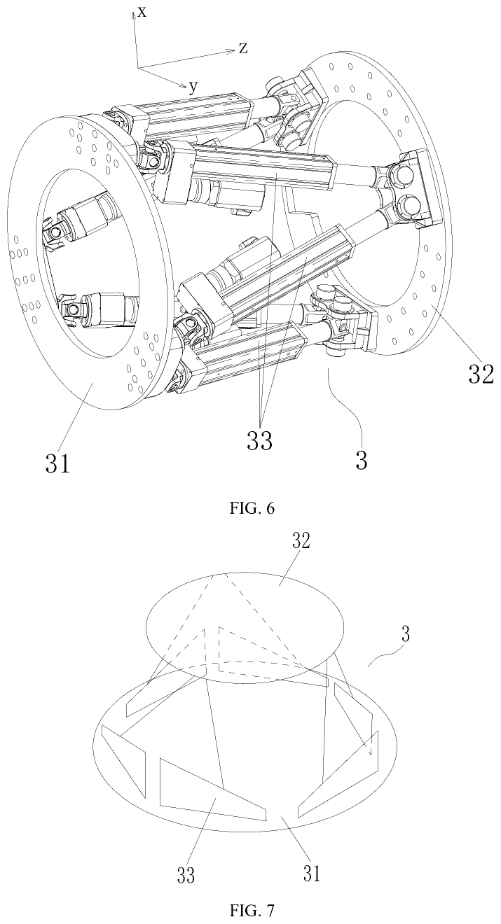

In this embodiment, as shown in FIG. 1, FIG. 2, and FIG. 6, the first connecting mechanism 3 is a controllable articulated connection that enables controlled deflection of the machine head 1 relative to the machine body 2. This allows the entire welding machine to bend, enabling it to navigate curved pipeline sections and improving its cornering capability. Specifically, the first connecting mechanism 3 includes a static end 31 and a movable end 32. The static end 31 is connected to the machine body 2, and the movable end 32 is connected to the machine head 1.

Multiple controllable movable members 33 are arranged in parallel between the static end 31 and the movable end 32, enabling relative movement between them. The first connecting mechanism 3 is a multi-degree-of-freedom parallel motion mechanism. Preferably, six movable members 33 are arranged in parallel between the static end 31 and the movable end 32. Therefore, the first connecting mechanism 3 forms a six-degree-of-freedom parallel motion structure and has six degrees of freedom. In terms of a three-dimensional Cartesian coordinate system, the first connecting mechanism 3 includes translational degrees of freedom along the x, y, and z axes and rotational degrees of freedom about the x, y, and z axes. Specifically, when the internal pipeline welding machine is positioned inside a pipe, the machine head 1 and machine body 2 are arranged in the axial direction of the pipe, so the static end 31 and movable end 32 of the first connecting mechanism 3 are also axially aligned. The pipe's axial direction is defined as the z-axis, and its cross-sectional plane is defined as the x-y plane. When the machine body 2 is inside the pipe, it maintains a stable state relative to the pipeline. Under the action of the first connecting mechanism 3, the machine head 1 can translate along the pipe axis, translate within the cross-sectional plane, rotate about the pipe axis, or rotate about any radial direction in the cross-sectional plane. Overall, the machine head 1 can be flexibly and precisely moved and deflected relative to the machine body 2 by the first connecting mechanism 3. This enables accurate matching with curved pipeline sections of various bending radii and allows the internal welding machine to deform into the required bending shape to smoothly pass through curved pipe sections.

In this embodiment, the movable member 33 is a linear telescopic member, with one end movably connected to the static end 31 and the other end movably connected to the movable end 32. Specifically, both ends of the linear telescopic member are connected to the static end 31 and the movable end 32 via universal joints. By controlling the extension and retraction of each linear telescopic member, the movable end 32 can be driven to move relative to the static end 31. The first connecting mechanism 3 provides motion in six degrees of freedom, allowing the movable end 32 to translate and deflect relative to the static end 31. This structure is compact, easy to control, and highly precise. The linear telescopic members can specifically be pneumatic cylinders, hydraulic cylinders, or electric actuators. In this embodiment, electric actuators are preferred. Compared to pneumatic or hydraulic types, electric actuators offer high transmission efficiency, fast response, high positioning accuracy, quiet operation, simple structure, easy maintenance, high reliability and safety, stable operation, and long service life. These advantages enable precise adjustment of the posture of the machine head 1, allowing it to deflect relative to the machine body 2 so that the internal welding machine can bend and pass through curved pipe sections, improving cornering capability. The machine head 1 can also translate along the axial direction of the pipeline, allowing the tensioning mechanism 11 and welding mechanism 12 on the machine head 1 to accurately align with the ends of the pipe ends, ensuring that the welding mechanism 12 is precisely aligned with the center of the weld seam between the two pipe ends and thus improving weld quality.

In this embodiment, the first connecting mechanism 3 specifically adopts a six-degree-of-freedom parallel motion mechanism. Alternatively, a six-degree-of-freedom serial motion mechanism may also be used, such as an articulated robotic arm, or three serially connected linear actuators, each equipped with a rotation mechanism. Due to the greater rigidity of six-degree-of-freedom parallel mechanisms, when compared under the same weight or volume conditions, the six-degree-of-freedom parallel motion mechanism possesses a higher load-bearing capacity than the six-degree-of-freedom serial motion mechanism. In serial mechanisms, the output error at the end effector is the accumulated and amplified result of individual joint errors, resulting in large overall motion errors and low accuracy. In contrast, the parallel mechanism does not exhibit error accumulation and amplification; instead, its overall motion error is the averaged result of the errors from all the parallel actuators, leading to lower error and higher micro-movement precision. Additionally, the drive motors and transmission systems of serial mechanisms are typically mounted on the moving joint arms, increasing system inertia and deteriorating dynamic performance. Parallel mechanisms, however, usually have their motors fixed on the non-moving static end, reducing dynamic load. The symmetrical structure of parallel mechanisms ensures even circumferential distribution and isotropic performance. They also operate in a smaller working space, making them suitable for confined environments, whereas serial mechanisms require a larger working space. Furthermore, position solving for serial mechanisms is straightforward in the forward kinematics but complex in the inverse kinematics, whereas parallel mechanisms have complex forward kinematics but simple inverse kinematics.

In the context of the parallel mechanism used herein, forward kinematics refers to solving the position and posture of the movable end based on known extension amounts of the actuators, while inverse kinematics refers to computing the required actuator extensions based on the desired position and posture of the movable end.

In the prior art, flexible deflection mechanisms are also used to connect the machine head and the machine body, enabling the machine head to deflect relative to the body to facilitate cornering. However, the flexible deflection mechanisms commonly adopted in existing technologies typically consist of universal joint structures or structures combining universal joints with elastic components. Such flexible deflection mechanisms operate in a passive manner; that is, deflection only occurs when the internal pipeline welding machine advances into a curved pipe section and the machine head contacts the inner wall of the curved section. The reaction force exerted by the inner wall causes the flexible deflection mechanism to actuate, thereby enabling the machine head to deflect relative to the machine body and pass through the curved section in a deflected state. During this process, the machine head remains in contact with the inner wall of the curved pipe, which easily leads to wear between the machine head and the pipe wall. By contrast, the first connecting mechanism 3 in this embodiment enables active deflection. It actively drives the movable end 32 to deflect relative to the static end 31 by means of controlling the first connecting mechanism. That is, as the pipe bends, the machine head 1 actively deflects relative to the machine body 2, allowing the entire internal welding machine to assume a curved configuration for smooth passage through the curved section. Preferably, the machine head 1 is actively maintained in a state in which its central axis is aligned with the central axis of the pipeline at its location. Since the welding mechanism 12 includes welding units 121 arranged circumferentially on the machine head 1, and the central axis of the welding mechanism 12 coincides with that of the machine head 1, aligning the machine head 1 with the pipeline ensures that the welding mechanism 12 is also coaxial with the pipeline at that location. As a result, the outer peripheries of the tensioning mechanism 11 and the welding mechanism 12 on the machine head 1 maintain a uniform clearance from the inner wall of the pipe throughout the entire circumference. During traversal of the curved section, the machine head does not come into contact with or collide with the inner wall of the curved pipe, thereby ensuring smoother and safer cornering performance. Of course, to achieve active and smooth cornering, it is sufficient for the machine head 1 to deflect relative to the machine body 2 without contacting the inner pipe wall. It is not strictly necessary for the central axis of the machine head 1 to be perfectly aligned with the pipeline's central axis at that location. The axes may be parallel or form a small angle, as long as there is a clearance between the machine head 1 and the pipeline around the entire circumference. Uniform clearance across all directions is not required.

In this embodiment, when the machine head 1 is connected to the machine body 2 via the first connecting mechanism 3, the bending operation can be manually controlled through the first connecting mechanism 3. Specifically, this means manually adjusting each movable member 33 in the first connecting mechanism 3 to enable the movable end 32 to move relative to the static end 31. In other words, the first connecting mechanism 3 is manually actuated to move or deflect the machine head 1 relative to the machine body 2. In practice, this may involve on-site visual observation, monitoring the position and posture of the machine head 1 relative to the curved pipe section, and manually operating the first connecting mechanism 3 until the gap between the machine head 1 and the inner wall of the curved section is approximately uniform around the circumference. That is, the machine head 1 deflects relative to the machine body 2 until its central axis aligns with the central axis of the pipeline at that location, allowing the internal pipeline welding machine to adaptively bend and smoothly pass through the curved section. Alternatively, if the bending radius of the pipe section is known in advance, the required deflection posture of the machine head 1 relative to the machine body 2 can be calculated. The first connecting mechanism 3 is then actuated, either manually or automatically, to achieve precise deflection, allowing the welding machine to actively conform to the curvature of the pipe and pass through smoothly.

### Embodiment 2

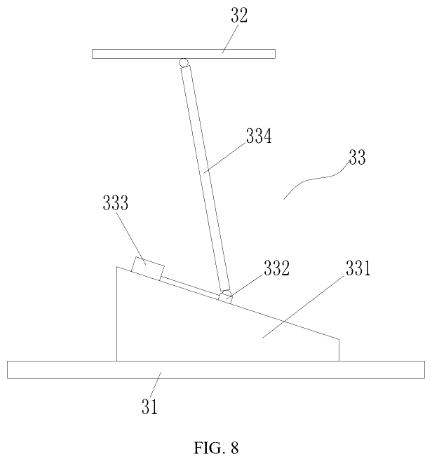

As shown in FIGS. 7-8, in this embodiment based on the first, the first connecting mechanism 3 is replaced with an alternative structure. The first connecting mechanism 3 includes a static end 31 and a movable end 32. The static end 31 is connected to the machine body 2, and the movable end 32 is connected to the machine head 1. Six controllable movable members 33 are arranged in parallel between the static and movable ends to enable relative movement. Specifically, each movable member 33 includes an actuator rod 334 and an oblique motion mechanism. The oblique motion mechanism includes an inclined slide rail 331, a slider 332, and a drive mechanism 333. The inclined slide rail 331 is fixed to the static end 31, and its sliding direction is inclined relative to the reference plane formed by the static end 31. The slider 332 is mounted on the slide rail 331 and is driven by the drive mechanism 333 to move along the rail 331. The drive mechanism 333 may be implemented as a motor-driven screw pair, a gear-and-rack mechanism, a synchronous belt system, or similar structures. The actuator rod 334 is a rigid, non-telescopic element. One end of the rod is connected to the slider 332 via a universal joint, and the other end is connected to the movable end 32 via another universal joint. Each pair of movable members 33 is symmetrically arranged as one group. The six movable members 33 between the static end 31 and the movable end 32 are grouped into three sets, which are evenly distributed around the circumference in a ring formation. Specifically, the inclined slide rails 331 form a regular hexagonal pattern when projected onto the reference plane of the static end 31. The inclined slide rail 331 forms an inclination angle of 20° to 50° relative to the reference plane defined by the static end 31. Different inclination angles correspond to different ranges of motion, thereby meeting varying operational requirements.

The aforementioned first connecting mechanism 3 is likewise a six-degree-of-freedom parallel motion mechanism. As the sliders 332 move along the inclined slide rails 331, they drive the ends of the actuator rods 334 to move synchronously along the same rails. By coordinating the slide fit of the sliders 332 on the six movable members 33 along their respective inclined slide rails 331, the movable end 32 can achieve six degrees of freedom in three-dimensional space. As a result, the movable end 32 is capable of performing translational and deflection motions relative to the static end 31. When this first connecting mechanism 3 is applied to the internal pipeline welding machine, it similarly enables the machine head 1 to perform controllable deflection relative to the machine body 2, allowing the internal pipeline welding machine to adopt a curved configuration. This, in turn, enables the machine to smoothly traverse curved pipeline sections and significantly enhances its cornering capability.

The first connecting mechanism may be either a parallel motion mechanism or a serial motion mechanism, and may be configured with only two or three controllable degrees of freedom, depending on the application. For a parallel motion mechanism, various configurations of multi-degree-of-freedom movement can be achieved by designing the number, structure, and connection method of the movable members arranged in parallel between the static and movable ends. Although the specific structures of the movable members differ between Embodiments 1 and 2, both implementations achieve six degrees of freedom. For example, three movable members may be arranged in parallel between the static and movable ends. These may be linear telescopic components, with two of them connected via universal joints at the static end and the movable end, and the third hinged at both ends. This configuration enables three degrees of freedom, including two translational and one rotational. The number and type of movable members can be adjusted as needed to form a multi-degree-of-freedom mechanism suitable for different applications. For a serial motion mechanism, varying the number and arrangement of joints allows for different degrees of freedom.

In applications where only cornering is required, the first connecting mechanism may include only two controllable degrees of freedom. According to the coordinate system shown in FIG. 6, these may be rotation about the x- and y-axes, x- and z-axes, or y- and z-axes. Specifically, when the machine body maintains a fixed orientation relative to the pipeline and moves along the pipe's axial direction, the first connecting mechanism with only two controllable degrees of freedom can deflect the machine head in any direction, enabling it to pass through pipe sections curved in any direction. For example, if the pipe curves around the y-axis, and the first connecting mechanism has two rotational degrees of freedom about the x- and y-axes, the mechanism can rotate around the y-axis to adjust the machine head's posture and achieve cornering. If the two controllable degrees of freedom of the first connecting mechanism are rotation about the x- and z-axes (with the first rotation axis along the x-axis and the second along the z-axis), The first connecting mechanism first performs a rotational movement around the z-axis via its second rotational axis, thereby reorienting its first rotational axis from the x-axis direction to the y-axis direction. Subsequently, the first rotational axis of the first connecting mechanism carries out a rotation around the y-axis, which also enables the machine head to deflect about the y-axis, thereby achieving cornering. Moreover, if the welding machine body itself is capable of rotating relative to the pipeline, then the first connecting mechanism requires only a single rotational degree of freedom (with a rotation axis in the x-y plane) to enable passage through pipe sections curved in any direction.

When the first connecting mechanism is used for weld seam alignment, it may be configured with three controllable degrees of freedom. Specifically, these three degrees of freedom can include a translational degree of freedom along the z-axis, as well as rotational degrees of freedom about the x- and y-axes. This configuration allows the machine head's deflection posture relative to the body to be adjusted by rotating around the x- and y-axes, preferably aligning the central axis of the welding mechanism with the pipe's central axis to achieve coaxial alignment. The translational movement along the z-axis enables the machine head to move axially along the pipe end, allowing the welding mechanism on the machine head to precisely align with the weld seam between the two pipes to be joined, thus enabling accurate weld alignment even in curved pipe sections. Alternatively, the three controllable degrees of freedom may include translational movement along the z-axis and rotational movements about the y- and z-axes, which can also accomplish precise seam alignment. If the welding machine's body itself is capable of rotational movement relative to the pipeline, then the first connecting mechanism needs only a translational degree of freedom along the z-axis and a single rotational degree of freedom (with a rotational axis lying in the x-y plane) to satisfy the alignment requirements.

### Embodiment 3

As shown in FIGS. 1-2, based on Embodiment 1 or 2, a sensor 4 is additionally mounted on the machine head 1 to detect the pipeline. The control system receives and analyzes the data collected by the sensor 4 to generate control parameters. The first connecting mechanism 3 operates according to these parameters to adjust the position and posture of the machine head 1. This embodiment utilizes the sensor 4 to automatically control the actions of the first connecting mechanism 3, determining the relative position and posture between the pipeline and the machine head 1. The machine head 1 is then automatically adjusted relative to the machine body 2 according to pipeline conditions, ensuring smooth cornering, accurate alignment, and high-quality welding operations. This significantly enhances automation and ensures consistent welding quality.

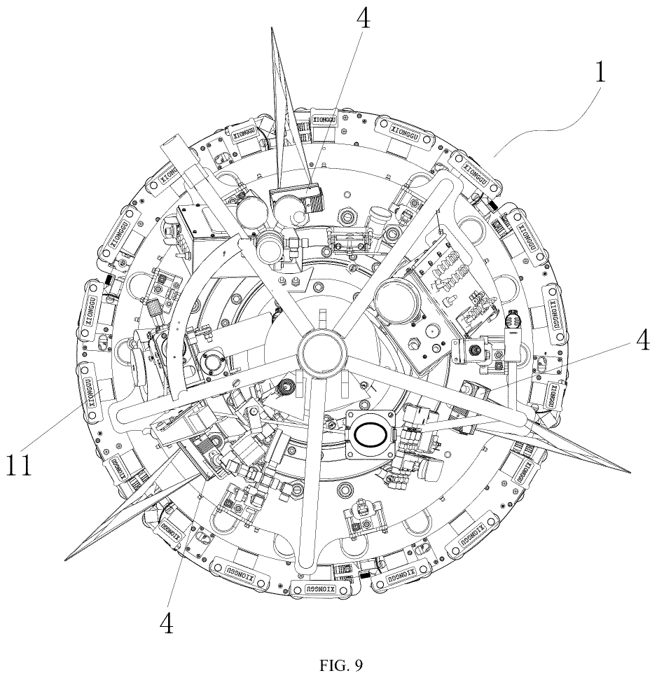

In this embodiment, multiple sensors 4 are circumferentially spaced around the welding machine's head 1, as shown in FIG. 9. Specifically, three sensors 4 are evenly distributed around the circumference, with the central axis of their circular arrangement coinciding with the central axis of the tightening mechanism 11 and the welding mechanism 12. By deploying sensors 4 at multiple angular positions, comprehensive pipeline detection is achieved, and the collected data are analyzed collectively to more accurately adjust the position and posture of the machine head 1.

Firstly, sensors 4 are used to determine whether the welding machine head 1 is aligned such that the central axis of the welding mechanism 12 coincides with the central axis of the pipeline at its current location (specifically, the pipeline includes both straight and curved sections. In the straight sections, the central axis of the pipeline is linear, and when the welding mechanism 12 is located within such a section, its central axis completely coincides with that of the pipeline. In the curved sections, the central axis of the pipeline is curved. When the welding mechanism 12 is located in a curved section, its central axis is aligned with the tangential direction of the pipeline's central axis at the corresponding cross-section. This can be referred to, in short, as the central axis of the welding mechanism 12 being aligned with the central axis of the pipeline). Since the central axis of the circumference on which the sensors 4 are positioned coincides with the central axis of the welding mechanism 12, a distance measurement approach can be employed. When the distances from all three sensors 4 to the inner wall of the pipe are equal, it can be determined that the central axis of the welding mechanism 12 is aligned with the central axis of the pipe at the corresponding position. This indicates that the machine head 1, which is equipped with the tightening mechanism 11, is centered within the pipe cross-section. During the operation of the internal pipeline welding machine as it travels along the pipeline, the sensors 4 perform real-time detection, and the first connecting mechanism 3 dynamically adjusts the position and posture of the machine head 1 to maintain alignment between the central axis of the welding mechanism 12 and the central axis of the pipe, allowing the welding machine to move smoothly along the pipeline. When the radial expansion of the tensioning mechanism 11 on the machine head 1 is not activated, the overall outer diameter of the machine head 1 is smaller than the inner diameter of the pipeline. As a result, the machine head 1 remains precisely at the center of the pipeline during operation and does not come into contact with the inner wall, thereby ensuring smooth and unobstructed passage.

When the internal pipeline welding machine passes through a curved section of the pipeline, the central axis of the pipeline bends accordingly. Through detection by the sensors 4 and automatic adjustment by the first connecting mechanism 3, the central axis of the welding mechanism 12 is kept aligned with the central axis of the pipeline at the corresponding position. This causes the machine head 1 to deflect relative to the machine body 2, resulting in an overall bending deformation of the welding machine, which enables it to smoothly pass through the curved section. Throughout the entire passage through the curved section, the machine head 1 remains aligned with the central axis of the pipeline, preventing contact or collision with the inner wall of the curved section and ensuring smooth cornering maneuverability.

In addition, the sensors 4 can be used for automatic alignment. Alignment herein refers to precisely positioning the welding mechanism 12 on the machine head 1 to face the weld seam between the grooves at the ends of two adjoining pipe sections. Specifically, the sensors 4 detect the location of the pipe ends, and the traveling system stops the welding machine at the target position, enabling the welding mechanism 12 on the machine head 1 to align with the weld seam. However, since the traveling system has limited positioning accuracy, it is difficult to align the welding mechanism 12 precisely with the weld center. Therefore, a cooperative approach between the traveling system and the first connecting mechanism 3 is adopted: the traveling system first halts the welding machine at a roughly accurate position near the weld seam. At this time, the welding mechanism 12 on the machine head 1 stays in the weld seam area between two adjacent pipelines and the first connecting mechanism 3 is then used to drive the machine head 1 for fine adjustment. This ensures that the welding torches of each welding unit on the welding mechanism 12 are precisely aligned with the weld seam center between the two pipe end grooves to be joined. This method offers a high degree of automation, eliminates the need for manual intervention, and significantly improves both alignment accuracy and operational efficiency, thereby enhancing the overall quality of the weld.

Specifically, in this embodiment, the sensors 4 are a stripe-type laser displacement sensor. The laser stripes emitted by the sensors 4 are projected onto the pipeline, thereby forming a laser profile line on the surface of the pipeline. The image of the laser profile line detected and collected by the sensors 4 constitutes the pipeline profile data. This pipeline profile data is transmitted to the control system for analysis and processing, allowing the current position and posture of the machine head 1 relative to the pipeline to be determined. The control system then analyzes the data to generate control parameters, which are sent to the first connecting mechanism 3. The first connecting mechanism 3 adjusts accordingly based on the control parameters to bring the machine head 1 into the required precise posture relative to the pipeline.

More specifically, the control system includes a coaxial unit, which is used to analyze and process the data collected by the sensors 4 in order to generate control parameters for coaxial alignment. The first connecting mechanism 3 operates based on these control parameters for coaxial adjustment (specifically, the various movable members 33 within the first connecting mechanism 3 perform corresponding movements to allow the movable end 32 to deflect and/or translate relative to the static end 31), so that the central axis of the welding mechanism 12 on the machine head 1 aligns with the central axis of the pipeline at the welding location. The coaxial unit is designed to maintain this alignment between the central axis of the welding mechanism 12 on the machine head and the central axis of the pipeline as the internal pipeline welding machine travels along the pipeline. When the pipeline bends, the first connecting mechanism 3 automatically drives the machine head 1 to deflect relative to the machine body 2 in accordance with the curvature of the pipeline. As a result, the entire internal pipeline welding machine assumes a curved form while maintaining the alignment between the central axis of the welding mechanism 12 and that of the pipeline, enabling it to smoothly pass through curved sections and thereby achieve automatic coaxial passage through bends.

Specifically, the traveling system mounted on the machine body 2 drives the machine body 2 to move along the pipeline toward the side where the machine head 1 is located. The sensors 4 are positioned on the forward side of the tensioning mechanism 11 and the welding mechanism 12 in the direction of travel, meaning the sensors 4 are located farther from the machine body 2 compared to the tensioning mechanism 11 and the welding mechanism 12. The emission direction of the laser stripe from the sensors 4 is toward the side where the tensioning mechanism 11 and the welding mechanism 12 are located, and this emission direction is inclined relative to the axial direction of the tensioning mechanism 11 and oriented toward the radial outer side of the tensioning mechanism 11. Furthermore, the length direction of the laser stripe lies within a plane that passes through the central axis of the tensioning mechanism 11. The laser stripe illumination region of the sensors 4 further covers the radial outer region that the welding mechanism 12 faces, thereby ensuring the real-time detection and accurate adjustment of the position and posture of the machine head 1 so that the welding mechanism 12 can be precisely aligned with the center of the weld seam between the two pipe ends.

The laser stripes emitted by the sensors 4 form a laser profile line on the inner wall of the pipeline. When the position and posture of the machine head 1 relative to the pipeline varies, the laser stripes emitted by the sensors 4 will form different shapes of profiles on the pipeline. Specifically, the deviation of the central axis of the welding mechanism 12 on machine head 1 from the central axis of the pipeline results in different laser profile shapes. For instance, when the machine head 1 is inside a straight pipe section and the axes of the welding mechanism 12 and the pipeline are completely aligned, the laser stripes emitted by the sensors 4 form a straight profile on the inner wall of the pipeline, as shown by the shaded region in FIG. 10. However, when there is an angular deviation between the central axis of the welding mechanism 12 and the central axis of the pipeline, the length direction of the laser stripes emitted by the sensors 4 become inclined relative to the axial direction of the pipeline. As a result, the laser stripes form a helical laser profile line on the inner wall of the pipeline, as shown in the shaded region of FIG. 11. By analyzing and processing the laser profile line image, the deviation of the central axis of the welding mechanism 12 from the central axis of the pipeline can be determined. This may be achieved by comparing the real-time laser profile line image collected by the sensors 4 with a preset reference profile line image (which can specifically be the standard laser profile line image formed by the laser stripes emitted onto the inner wall of the pipeline when the central axis of the welding mechanism 12 is perfectly aligned with the central axis of the pipeline). Based on this comparison, control parameters for coaxial alignment are obtained, and the first connecting mechanism 3 is automatically controlled to operate accordingly, thereby maintaining the machine head 1 in a state where the central axis of the welding mechanism 12 is aligned with the central axis of the pipeline. This allows the internal pipeline welding machine to travel smoothly along the pipeline and pass smoothly through curved sections, thereby achieving automatic cornering.

The cooperation between the first connecting mechanism 3 and the sensors 4 not only enables automatic coaxial cornering, but also enables automatic and precise alignment. The term “alignment” refers to adjusting the position and posture of the machine head 1 such that the welding mechanism 12 on the machine head 1 is precisely aligned with the center of the weld seam between the grooves of the two pipe ends to be joined. The control system includes an alignment unit, which analyzes and processes the data detected and collected by the sensors 4 to obtain control parameters for alignment. The first connecting mechanism 3 then operates according to these parameters to align the welding mechanism 12 with the weld seam center between the two pipe ends to be joined. The first connecting mechanism 3 is a multi-degree-of-freedom motion mechanism, specifically a parallel or serial motion mechanism, with between two and six degrees of freedom. The number of degrees of freedom must be sufficient to meet the needs of alignment adjustment. The first connecting mechanism 3 has a certain range of movement, and as long as the positional error between the current position of the welding mechanism 12 and the optimal alignment position is within this range, the mechanism can adjust to precisely align the welding mechanism 12 with the center of the weld seam, thereby achieving precise alignment.

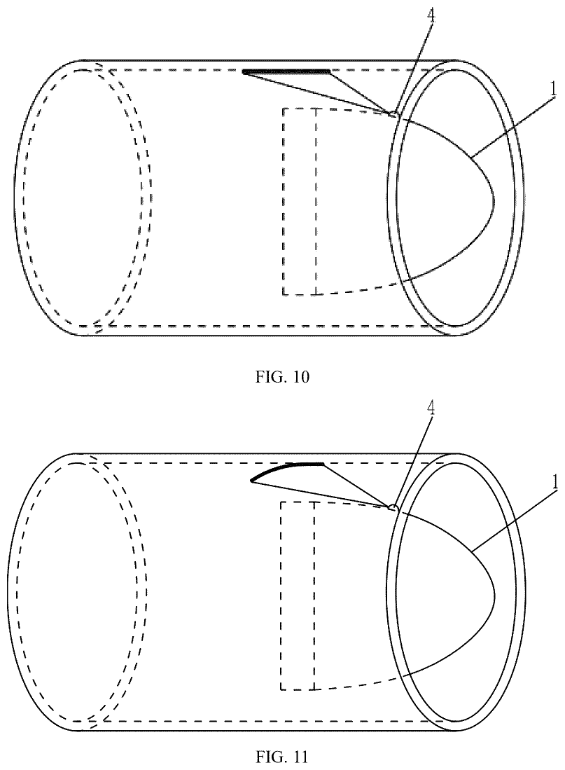

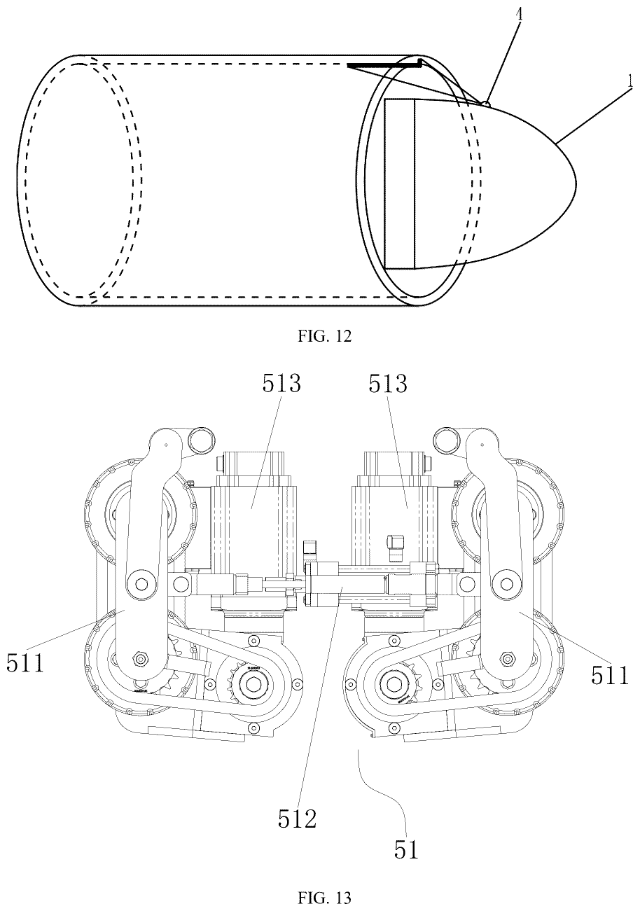

Specifically, with reference to FIG. 10 and FIG. 12, different shapes of laser profiles are formed depending on the position of the machine head 1 relative to the pipe end. Assuming that the machine head 1 of the internal pipeline welding machine is traveling along the pipeline while maintaining alignment between the central axis of the welding mechanism 12 and the central axis of the pipeline, when the machine head 1 is fully located within a straight section of the pipeline, or when both the tensioning mechanism 11 and the welding mechanism 12 are still completely within the straight pipe section, the laser stripes emitted by the sensors 4 are projected only onto the inner wall of the pipeline, forming a straight laser profile line, as shown in the shaded region of FIG. 10. However, as the internal pipeline welding machine continues to move forward and the laser stripes emitted by the sensors 4 reaches the groove of the pipe end, the resulting laser profile line becomes approximately L-shaped, as shown in the shaded region of FIG. 12. This change in the profile shape allows for the determination of the position and posture of the machine head 1 relative to the pipe end by analyzing the laser profile line image. This may be achieved by comparing the real-time laser profile line image collected by the sensors 4 with a preset reference profile line image (which can specifically be the standard laser profile line image formed by the laser stripes emitted onto the inner wall of the pipeline when the central axis of the welding mechanism 12 is perfectly aligned with the central axis of the pipeline). Through this comparison, it can be determined whether the sensors 4 has scanned and detected the pipe end, thereby identifying the distance between the machine head 1 and the pipe end. This enables the automatic control of the traveling system in coordination with the first connecting mechanism 3 to adjust the position of the machine head 1 such that the welding mechanism 12 is precisely aligned with the center of the weld seam between the two pipe ends, ultimately achieving automatic alignment.

The alignment unit includes:
a scene determination module, which is used to analyze and process the data detected and collected by the sensors 4 in order to determine whether the sensors 4 has detected an alignment scene at the pipe end. As the internal pipeline welding machine travels along the pipeline via the traveling system, the laser stripes emitted by the sensors 4 are projected onto the pipeline to form a laser profile line. When the position of the machine head 1 relative to the pipe end varies, the laser profile line formed by the sensors 4 takes on different shapes. Specifically, the laser profile line formed when the laser stripes are projected only onto the inner wall of the pipe is different in shape from the profile formed when the stripes are projected onto the pipe end. By analyzing the laser profile line image detected and collected by the sensors 4, the position of the machine head 1 relative to the pipe end can be determined. When the laser stripes are projected only onto the inner wall of the pipe, it indicates that the welding mechanism 12 on the machine head 1 is still at a considerable distance from the pipe end. At this point, the system is not in the alignment scene but rather in a positioning/traveling scene, and the internal pipeline welding machine continues to advance along the pipeline via the traveling system. When the laser stripes emitted by the sensors 4 reach the pipe end, it indicates that the welding mechanism 12 on the machine head 1 is near the pipe end, this marks the transition into the alignment scene, and automatic alignment actions begin. Specifically, the sensors 4 detect and collect a pipeline profile line image. The scene determination module compares this collected image with a preset reference image to determine whether the pipe end has been detected by the sensors 4. The preset image is a standard profile line image including the pipe end, collected by the sensors 4 under the condition where the central axis of the welding mechanism 12 is aligned with the central axis of the pipeline. When the real-time profile line image detected by the sensors 4 matches the preset image, it indicates that the machine head 1 is in a coaxial posture, where the central axis of the welding mechanism 12 is aligned with that of the pipeline. In other words, upon entering the alignment scene, the machine head 1 is already in a coaxial posture, which facilitates the efficiency and accuracy of subsequent alignment adjustments. During the process in which the traveling system drives the internal pipeline welding machine along the pipeline, the coaxial unit continuously operates to maintain the coaxial posture of the machine head 1, i.e., alignment of the welding mechanism 12's central axis with the pipeline's central axis, thereby ensuring that this alignment state is preserved upon entering the alignment scene.
a measurement module, when in the alignment scene, analyzes and processes the sensor data to obtain the distance from the sensors 4 to the plane of the pipe end. The sensor data consists of laser profile line images, which contain various types of information. By analyzing these laser profile line images, the current relative position between the pipe end and the sensors 4 can be determined. Since the welding mechanism 12 on machine head 1 has a fixed and definite positional relationship with the sensors 4, the current relative position between the pipe end and the welding mechanism 12 can also be derived. This facilitates the subsequent pose adjustment of the machine head 1 via the first connecting mechanism 3, so that the welding mechanism 12 is accurately aligned with the center of the weld seam between the end grooves of the two pipelines to be joined.
a parking module, when the distance from the sensors 4 to the plane of the pipe end reaches a predefined parking condition, issues a command to the traveling system to stop the machine body 2. Specifically, this command may be issued when the distance from the sensors 4 to the pipe end falls within a preset range. Given the relatively low positioning accuracy of the traveling system, relying solely on the traveling system to stop the machine body 2 does not ensure that the welding mechanism 12 is exactly aligned with the weld seam center between the end grooves of the two pipelines. Therefore, the internal pipeline welding machine is first brought to a coarse stop by the traveling system, such that the welding mechanism 12 is located in the vicinity of the weld seam between the end grooves of two pipelines to be joined. The first connecting mechanism 3 is then used to precisely adjust the position and posture of the machine head 1, allowing the welding mechanism 12 to be accurately aligned with the center of the weld seam. This approach ensures high alignment efficiency and precision. More specifically, multiple sensors 4 can be arranged circumferentially on the machine head 1, at least two, for instance. When either at least two or a majority of the sensors 4 detect that the distance to the pipe end reaches the parking condition, the parking module issues a command to the traveling system to stop the machine body 2.
a fine alignment module, analyzes and processes the data detected and collected by the sensors 4 while the machine body 2 is in a stationary state, in order to generate control parameters for fine adjustment (these alignment control parameters include both the command to stop the traveling system and the control parameters for fine-tuning). While the traveling system keeps the machine body 2 stationary within the pipeline, the first connecting mechanism 3 operates based on the fine adjustment control parameters (specifically, various movable members 33 within the first connecting mechanism 3 perform corresponding actions to deflect and/or translate the movable end 32 relative to the static end 31). When the distance between the sensors 4 and the pipe end reaches the preset alignment distance, the first connecting mechanism 3 stops its motion. At this point, the welding mechanism 12 is precisely aligned with the center of the weld seam between the two pipelines, and its central axis is aligned with the central axis of the end grooves of the pipeline. The tensioning mechanism 11 then expands radially outward to clamp and fix the pipeline in place, allowing the welding mechanism 12 to proceed with the welding operation.

In this embodiment, the alignment method for the internal pipeline welding machine involves the traveling system driving the entire welding machine to move within the pipeline, such that the machine head 1 advances from inside the pipeline toward the outside of the pipe end. The control system analyzes and processes the data detected and collected by the sensors 4 to determine whether the pipe end has been detected by the sensors 4, i.e., whether the welding machine has entered the alignment scene. The data collected by the sensors 4 includes laser profiles of the pipeline. The control system analyzes these laser profiles, specifically by comparing the pipeline profile line images collected by the sensors 4 with preset reference images, to determine whether the pipe end has been detected. For example, when the laser profile appears as a straight line (as shown in FIG. 10), it indicates that the laser stripes emitted by the sensors 4 are projected only onto the inner wall of the pipeline. At this point, the tensioning mechanism 11 and the welding mechanism 12 on the machine head 1 are still at a considerable distance from the pipe end, and the welding machine is still in the positioning/traveling scene. The traveling system continues to operate, driving the welding machine forward along the pipeline. When the laser profile line changes to an L-shape (as shown in FIG. 12), it indicates that the laser stripes from the sensors 4 have reached the end groove of the pipe end, in other words, the pipe end has been detected by the sensors 4, and the welding machine has now entered the alignment scene.

Once in the alignment scene, the control system analyzes the pipeline profile data (laser profile line images) collected by the sensors 4 to calculate the distance from the sensors 4 to the plane of the pipe end. This distance is then used to control the traveling system and determine the parking position of the machine body 2.

The traveling system continues operating, causing the welding machine to move further along the pipeline, with the machine head 1 continuing to move toward the outer side of the pipe end. As a result, the distance from the sensors 4 to the plane of the pipe end continues to increase. When this distance reaches a predefined parking condition (which may be a specific preset distance value that can be configured as needed), the traveling system stops the machine body 2. In other words, the machine body 2 of the internal welding machine is stopped inside the pipeline, and the welding mechanism 12 on the machine head 1 is positioned in the vicinity of the weld seam between the two pipe ends. Specifically, the machine body 2 may stop by the traveling system when the distance from the sensors 4 to the plane of the pipe end exceeds the preset value. Preferably, the parking condition is set such that, when the traveling system halts the machine body 2, the welding mechanism 12 is still located inside the pipe end. This allows the machine head 1 to be further moved toward the outer side of the pipe end by the adjustment function of the first connecting mechanism 3, thereby enabling the welding mechanism 12 to be precisely aligned with the center of the weld seam between the two pipe ends.

When the traveling system has stopped the machine body 2, the control system analyzes and processes the laser profile line images currently detected and collected by the sensors 4 to obtain control parameters. The first connecting mechanism 3 then operates based on these control parameters to drive the machine head 1 for fine adjustment. When the distance between the sensors 4 and the plane of the pipe end reaches the preset alignment distance, the first connecting mechanism 3 stops operating. (Accurate automatic alignment is achieved by precisely controlling the distance between the sensors 4 and the pipe end plane. Since the distance between the welding mechanism 12 and the sensors 4 along the axial direction of the tensioning mechanism 11 is fixed and definite, the preset alignment distance is effectively equal to the distance between the welding mechanism 12 and the sensors 4 in the axial direction of the tensioning mechanism 11, plus half the width of the weld seam between the end grooves of the two pipelines. Therefore, when the distance between the sensors 4 and the pipe end plane reaches the preset alignment distance, it can be determined that the welding torches of the individual welding units within the welding mechanism 12 are precisely aligned with the center of the weld seam between the two end grooves, thereby achieving precise automatic alignment.) Specifically, three sensors 4 are evenly arranged along the circumference, and when all three sensors 4 detect that the distance to the pipe end plane has reached the preset alignment distance, the welding mechanism 12 is precisely aligned with the center of the weld seam between the two pipelines to be joined, completing the automatic alignment operation.

During the automatic alignment process, the central axis of the welding mechanism 12 on machine head 1 remains aligned with the central axis of the pipeline. In other words, as the internal pipeline welding machine is driven forward by the traveling system, the control system continuously analyzes the data collected by the sensors 4 to obtain control parameters for coaxial alignment. The first connecting mechanism 3 operates based on these coaxial control parameters to maintain the machine head 1 in a state where the central axis of the welding mechanism 12 coincides with that of the pipeline. Even after the traveling system has stopped the machine body 2 and the first connecting mechanism 3 begins the fine adjustment process, this coaxial alignment of the central axis of the welding mechanism 12 with that of the pipeline is still maintained. Moreover, after the automatic alignment is completed, the central axis of the welding mechanism 12 must also be aligned with the central axis of the end grooves of the pipeline, so that the tensioning mechanism 11 can expand radially in a balanced and stable manner to clamp and secure the pipeline, thereby ensuring that the welding mechanism 12 can accurately perform welding at the weld seam between the two pipelines to be joined.

In addition to the specific sensor structure described above, other sensor configurations may also be used. For example, the stripe-type laser displacement sensor may be replaced with a distance sensor, vision system, or other types. The sensors may also be arranged differently or installed at other positions, for instance, mounted on the machine body 2. As another example, a circular track may be installed on the machine head 1, with the central axis of the circular track aligned with the central axis of the welding mechanism 12. The sensor may be mounted on the circular track to move along it and can stop at any position on the circular track to perform detection of the pipeline. This allows data to be collected from any position along the circumferential direction of the pipeline, resulting in more accurate detection and improved flexibility and adaptability.

### Embodiment 4

As shown in FIG. 1, FIG. 2, and FIG. 13, based on Embodiment 1, the traveling system on the machine body 2 specifically includes a traveling mechanism 51. The traveling mechanism 51 includes a number of traveling wheel assemblies 511 arranged circumferentially at intervals around the machine body 2. These traveling wheel assemblies 511 are connected to pressing mechanisms 512 mounted on the machine body 2. Each traveling wheel assembly 511 is a driving wheel mechanism, used to propel the machine body 2 along the interior of the pipeline. The pressing mechanisms 512 are used to press the wheel assemblies 511 tightly against the inner wall of the pipeline, ensuring sufficient friction between the traveling wheel assemblies 511 and the pipe wall. This prevents slippage or skidding during operation of the traveling wheel assemblies 511, improves the climbing capability of the internal pipeline welding machine, and makes it suitable for steeply inclined pipe sections.

Specifically, the traveling wheel assemblies 511 are arranged in pairs on opposite sides along the diameter of the machine body 2. The pressing mechanism 512 is a pressing hydraulic cylinder connected between the two traveling wheel assemblies 511 and mounted on the machine body 2. The extension and retraction of the hydraulic cylinder drive the wheel assemblies 511 to move along the diameter of the machine body 2 and press against the pipe's inner wall. This structure is simple and compact. Using hydraulic power for the pressing force enables a stronger clamping force without increasing the size of the mechanism, effectively preventing wheel slippage or skidding and enhancing climbing ability, thereby improving the internal welding machine's safety and reliability during pipeline travel.

Further, each traveling wheel assembly 511 is equipped with a traveling motor 513, which is a motor with an integrated holding brake. Compared to conventional pneumatic motors, this configuration offers greater torque and enables self-locking via the brake. When the traveling motor 513 engages the brake, the wheels of the traveling wheel assembly 511 cannot rotate, providing more safety when the welding machine needs to stop on an inclined pipeline section. Because each traveling wheel assembly 511 is driven by an independent traveling motor 513, the traveling wheel assemblies 511 on the left and right sides can operate independently. In other words, the travel speeds of the left and right wheel assemblies 511 can differ, allowing the welding machine to achieve differential steering when passing through curved pipe sections. Specifically, electronic differential control is employed to adjust the travel speed of each traveling wheel assembly 511. Since the inner and outer bends of a pipe bend have different radii, smooth cornering requires the traveling wheel assembly 511 on the outer bend to rotate faster than the one on the inner bend.

More specifically, when the internal pipeline welding machine is navigating a bend, if the two traveling motors use identical control parameters, the traveling wheel assembly on the outer bend would rotate at the same speed as the one on the inner bend. In speed control mode, the speed is required to remain constant. If both motors are operating at the same speed during this time, the wheels of the traveling wheel assembly on the outer bend side and those on the inner bend side will encounter different levels of resistance. To maintain constant motor speeds under such conditions, the motor drivers for the outer and inner bend sides must generate different driving forces. These subtle differences in torque can be detected by the respective motor drivers of the two traveling motors and used as input feedback values. Through PID (Proportional-Integral-Derivative) adjustment, the system can dynamically adjust the running speeds of the outer and inner traveling wheel assemblies in real time, thereby achieving differential steering between the inner and outer wheels and ensuring smooth operation of the equipment. In contrast, traditional internal pipeline welding machines, which lack differential wheel control during navigation through curved pipe sections, tend to get stuck at bends. In such cases, the traveling motors must overcome significant binding forces to force their way through, which can easily lead to equipment damage.

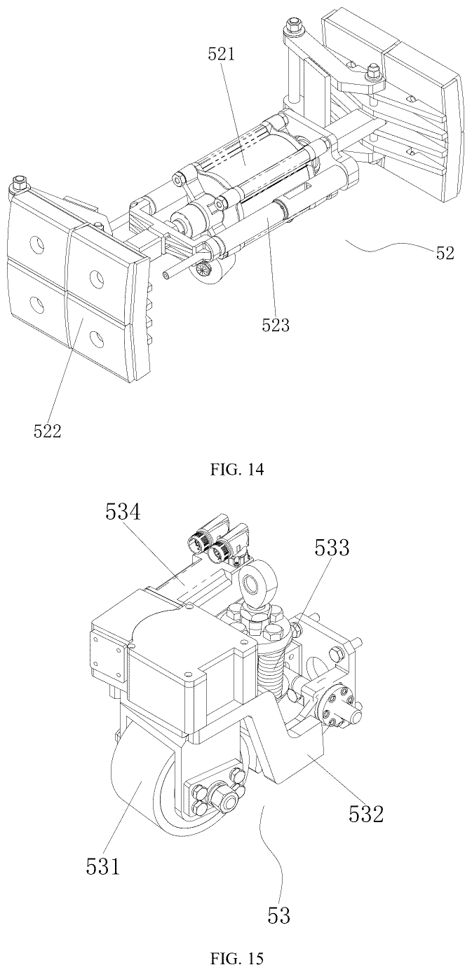

Further, as shown in FIG. 1, FIG. 2, and FIG. 14, the traveling system also includes a brake mechanism 52. The brake mechanism 52 specifically includes a brake cylinder 521, a brake pad 522, and an elastic retaining member 523. The brake cylinder 521 is connected on the machine body 2 and drives the brake pad 522 to switch between a braking position and a release position. When the brake pad 522 is in the braking position, it is pressed tightly against the inner wall of the pipeline by the brake cylinder 521 to achieve reliable braking, ensuring the internal pipeline welding machine can stably stop within the pipeline. Even when located on an inclined pipe section, the system prevents sliding, thereby enhancing safety and reliability. When the brake pad 522 is in the release position, it separates from the inner wall of the pipe, allowing the welding machine to travel smoothly under the drive of the traveling mechanism 51. The brake pad 522 is also connected to the elastic retaining member 523, which is used to keep the brake pad 522 in the braking position. This ensures that even if the brake cylinder 521 fails, the brake pad 522 can still remain in the braking position under the action of the elastic retaining member 523, thereby preventing slippage. Braking can only be released when the brake cylinder 521 is functioning normally and actively retracts the brake pad 522 to the release position. The elastic retaining member 523 is specifically a gas spring, which has a relatively slow speed, minimal dynamic force variation, and is easy to control. It features a nearly linear elastic curve, providing a more stable pressing force on the brake pad and ensuring consistent braking performance.

Further, as shown in FIG. 1 and FIG. 15, the traveling system also includes a flexible wheel assembly 53, which is arranged near the front portion of the machine body 2. The front portion of the machine body 2 refers to the side near the machine head 1. The traveling wheel assemblies 511 are located in the middle section of the machine body 2, and rear wheels 54 are provided at the rear portion of the machine body 2. Both the flexible wheel assembly 53 and the rear wheels 54 are idler wheels. The machine body 2 is supported against the inner wall of the pipeline via the flexible wheel assembly 53, the traveling wheel assemblies 511, and the rear wheels 54, enabling it to travel reliably along the inner wall of the pipeline.

The flexible wheel assembly 53 specifically includes wheels 531, wheel seats 532, and elastic members 533. The wheels 531 are mounted on the wheel seats 532, and the wheel seats 532 are hinged to the machine body 2. The rotation plane of the wheel seats 532 is oriented radially with respect to the machine body 2. The elastic members 533 are connected between the wheel seats 532 and the machine body 2. The elastic members 533 are specifically flexible springs. The wheels 531 in the flexible wheel assemblies 53 can move radially relative to the machine body 2 through the hinged wheel seats 532, enabling cushioning and extension. When the internal pipeline welding machine is subjected to external forces, such as when the tensioning mechanism presses against the pipe wall or the machine head 1 contacts the pipe wall, the wheels 531, along with the wheel seats 532, deflects relative to the machine body 2, causing the elastic members to deform elastically. This elastic deformation absorbs impact forces and effectively prevents damage to the welding machine, thereby providing reliable protection.

Additionally, the flexible wheel assembly 53 further includes an angle adjustment motor 534 mounted on the wheel seat 532 and connected to the wheel 531. The angle adjustment motor 534 is used to steer the wheel 531 to change its traveling direction. During the welding machine's movement along the inner wall of the pipeline, it is difficult to maintain a constant posture. The internal pipeline welding machine may inevitably rotate relative to the pipeline. For example, if the machine rotates clockwise to the left while traveling through a horizontally oriented pipeline, the angle adjustment motor 534 can steer the wheel 531 slightly to the right. This generates a guiding force that causes the machine to rotate counterclockwise, restoring it to its normal posture. A gyroscope can be installed on the machine body 2 of the internal pipeline welding machine to monitor its posture. Based on the data from the gyroscope, the control system adjusts the steering direction of the wheel 531 via the angle adjustment motor 534, thereby enabling automatic posture correction.

### Embodiment 5

As shown in FIG. 1, based on Embodiment 4, the internal pipeline welding machine further includes a battery unit 6 integrated into the machine body 2. The battery unit 6 supplies power to the tensioning mechanism 11, the welding mechanism 12, the traveling system, the first connecting mechanism 3, and other components. With a power distribution management system, the energy is managed efficiently and economically. The battery unit 6 uses lithium batteries and incorporates a BMS (Battery Management System) to enhance safety performance. Additionally, the battery unit 6 is equipped with a heating component to warm the battery when it is under low-temperature conditions, so as to improve its operation safety and reliability. The system supports fast charging, ensuring that the battery can be fully charged within 1.5 hours, significantly improving on-site work efficiency.

The internal pipeline welding machine also includes an integrated welding power supply 7 on the machine body 2, which eliminates the need for a traditional external delivery rod, thereby greatly simplifying field operation. The welding power supply 7 integrates multiple traditional welding power units and includes three or four positive welding cables and one negative welding cable. They are powered by the built-in battery unit 6, and the welding power supply 7 is electrically connected via welding cables to the welding units within the welding mechanism 12.

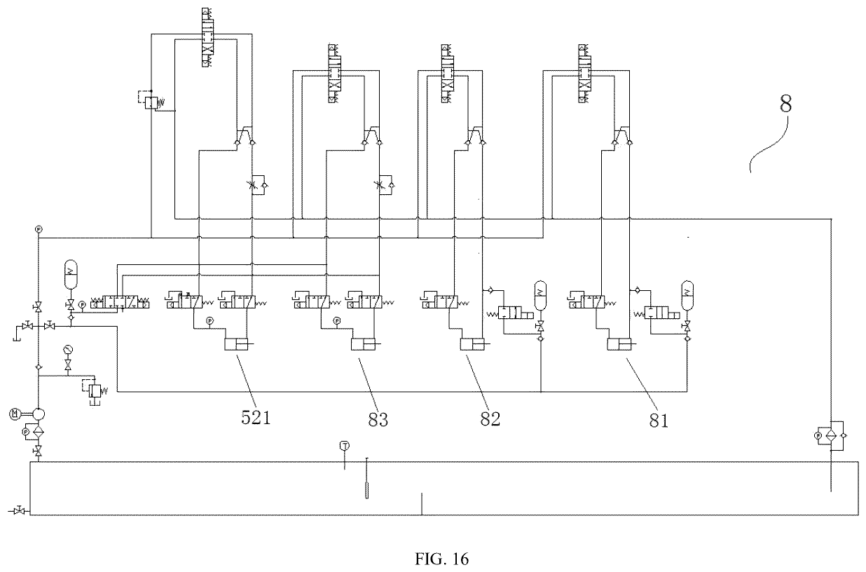

Further, the machine body 2 is also integrated with a hydraulic system 8, which provides hydraulic power for the tensioning mechanism 11, the brake mechanism 52, and the pressing mechanism 512 of the traveling system 51. As shown in FIG. 16, the hydraulic system 8 includes a front tensioning cylinder 81, a rear tensioning cylinder 82, a traveling cylinder 83, and a brake cylinder 521, all arranged in parallel. The front tensioning cylinder 81 corresponds to the front tensioning assembly 111 of the tensioning mechanism 11, and the rear tensioning cylinder 82 corresponds to the rear tensioning assembly 112, enabling secure clamping of the pipeline. The traveling cylinder 83 corresponds to the pressing mechanism 512 of the traveling mechanism 51, allowing the traveling wheel assemblies 511 to be tightly pressed against the inner wall of the pipeline, thereby ensuring stable movement. Each of the front tensioning cylinder, the rear tensioning cylinder, the traveling cylinder, and the brake cylinder is connected to a directional valve, allowing the hydraulic system 8 to flexibly control the operating state of each cylinder, thereby enabling the corresponding functions of each component. In addition, a protective gas cylinder 9 is also integrated into the machine body 2. The protective gas cylinder 9 supplies shielding gas to the welding mechanism 12, ensuring welding quality.

### Embodiment 6

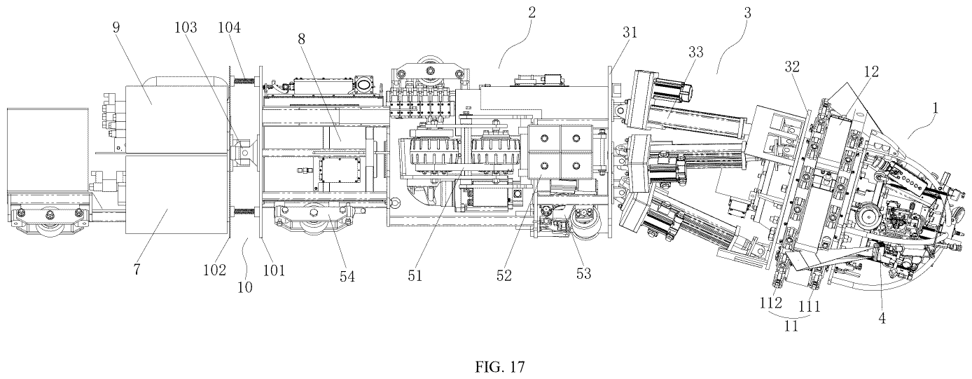

As shown in FIG. 17, based on Embodiment 5, the machine body 2 is divided into multiple modular segments along the axial direction of the pipeline. Adjacent segments are connected via a second connecting mechanism 10, which is a deflectable (articulated) connection mechanism. The second connecting mechanism 10 may adopt the same structure as the first connecting mechanism 3 described in Embodiment 1, that is, it can also be an actively controllable articulated connection mechanism. However, compared to the machine head 1 that carries the tensioning mechanism 11 and the welding mechanism 12, the individual segments of the machine body 2 require less precision in posture control. It is sufficient for the segments of the machine body 2 to be capable of relative deflection to improve cornering performance. Therefore, the second connecting mechanism 10 may adopt a passive articulated connection structure.

Specifically, in this embodiment the machine body 2 includes only two segments. The second connecting mechanism 10 between these two segments includes a first end 101, a second end 102, a universal joint 103, and a flexible connecting component 104. The universal joint 103 and the flexible connecting component 104 are connected between the first end 101 and the second end 102. A number of the flexible connecting components 104 are distributed circumferentially around the universal joint 103. The first end 101 is connected to the preceding segment, and the second end 102 is connected to the following segment. The second connecting mechanism 10 has a simple structure and is easy to implement. This second connecting mechanism can deflect passively without active adjustment. When the internal welding machine passes through a curved pipe section, each segment of the machine body 2 contacts the inner wall of the pipeline. Under the force of the pipeline's inner wall pressing against each segment, the adjacent segments undergo relative deflection via the second connecting mechanism to match the bend radius of the curved pipe section. As a result, the segments of the machine body 2 change from an originally straight alignment to a curved alignment, and the bent shape of the machine body 2 at this time matches the bend radius of the curved pipe segment. Accordingly, the internal welding machine can smoothly pass through the curved segment, further improving its cornering ability.

Furthermore, the machine body 2 is divided into two segments, and modules with different functions are integrated on each segment by category. The segment near the machine head 1 is mainly equipped with the traveling system and the battery unit. Specifically, the segment near the machine head 1 is provided with a traveling mechanism 51, a brake mechanism 52, a flexible wheel assembly 53, and a rear wheel 54, etc. The segment farther from the machine head 1 primarily serves as an energy segment. On the segment away from the machine head 1, components such as a shielding gas cylinder 9, a welding power supply 7, and a hydraulic oil tank are mainly provided.

### Posture Adjustment System of the Internal Pipeline Welding Machine

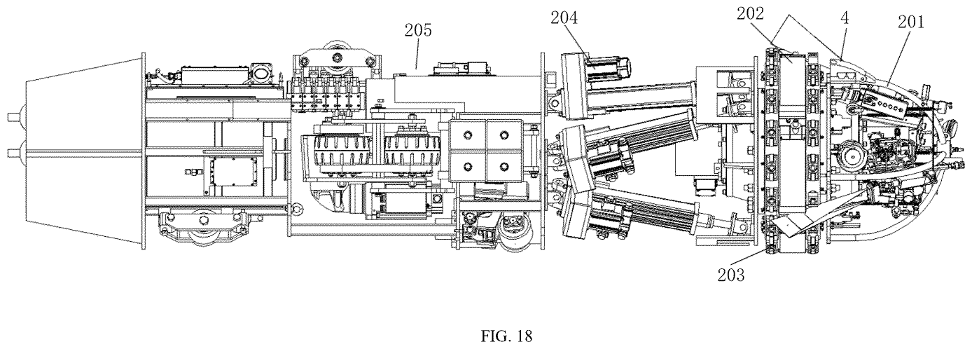

This embodiment provides an internal welding machine posture adjustment system. The system includes a posture adjustment device 204, an electrical control module, and a sensor 4. The posture adjustment device 204 is disposed between a first segment 201 and a second segment 205 of the internal pipeline welding machine. The electrical control module can control the posture adjustment device 204 to adjust the posture of the internal pipeline welding machine based on data collected by the sensor 4. Specifically, the posture adjustment device 204 can be installed between any two segments of the internal pipeline welding machine. Each segment may be a rigid, non-rotatable member, or the segment may additionally be designed with an articulated structure. As a preferred embodiment of the present application, as shown in FIG. 18, the first segment 201 is a cone assembly, which is provided with electrical components, a tensioning assembly 203, and a welding mechanism. The second segment 205 is a machine body mechanism, which is provided with a traveling device, a braking device, a driving device, etc.

The posture adjustment device 204 includes a movable platform 2041, a fixed platform 2043, a linear actuator 2042, and universal joints. The movable platform 2041 is integrally formed with the frame of the first segment 201, and the fixed platform 2043 is integrally formed with the frame of the second segment 205. Both ends of the linear actuator 2042 are connected via universal joints to the movable platform 2041 and the fixed platform 2043, respectively. Each linear actuator 2042 corresponds to two universal joints. In other words, the first end of the linear actuator 2042 is connected to the movable platform 2041 by one universal joint, and the second end of the linear actuator 2042 is connected to the fixed platform 2043 by another universal joint. Further, the posture adjustment device 204 is a six-degree-of-freedom motion platform including six linear actuators 2042. For a posture adjustment device 204 disposed between any two segments of the internal pipeline welding machine, through detection by the sensor 4 and active driving of the posture adjustment device 204, the side attached to the movable platform 2041 can adapt to the pipeline profile, allowing the internal pipeline welding machine to travel freely inside the pipeline without collision. In the above preferred embodiment, the movable platform 2041 is mounted on the cone assembly side; that is, in this case the movable platform 2041 is positioned near the tensioning assembly 203 and the welding device 202. This configuration allows the posture adjustment device 204 to flexibly adjust the cone assembly (including the tensioning assembly 203 and the welding device 202), so that the head of the internal pipeline welding machine can better adapt to the pipeline.

The sensor 4 is used to collect pipeline profile data at the location of the internal pipeline welding machine. The posture adjustment device 204 may include multiple sensors 4 in order to gather comprehensive pipeline profile data.

The electrical control module is configured to calculate the target posture of the first segment 201 based on the pipeline profile data, and to perform an inverse kinematics computation on the target posture to generate a length-change signal for the linear actuator 2042. The electrical control module is further configured to use the length-change signal to control the linear actuator 2042 to extend and retract, so that the first segment 201 is placed in the target posture. Specifically, this embodiment can determine the current relative position of the pipeline and the internal welding machine from the pipeline profile data, and determine the target posture of the first segment 201 according to this current relative position. The target posture may be one that allows the internal pipeline welding machine to travel normally inside the pipeline without colliding.

The posture adjustment device 204 provided in this embodiment is disposed between the first segment 201 and the second segment 205 of the internal welding machine. Since the movable platform 2041 and the frame of the first segment 201 are integrally structured, and the fixed platform 2043 and the frame of the second segment 205 are also integrally structured, the posture of the first segment 201 can be altered when the linear actuator 2042 of the posture adjustment device 204 performs telescopic motion. In the operation of the electrical control module in this embodiment, the target posture of the first segment 201 is calculated based on the pipeline profile data, and an inverse kinematics algorithm is executed to generate a length variation signal for the linear actuator. The linear actuator 2042 is then controlled to perform telescopic motion based on the length variation signal, such that the first segment 201 reaches the target posture. This embodiment allows for automated posture adjustment of the internal welding machine based on pipeline profile data, thereby improving welding quality.

As a feasible embodiment, the above-mentioned posture adjustment system includes multiple sensors 4, all of which are evenly distributed around the first segment 201 and lie in the same plane. The installation positions of all the sensors 4 are substantially in a single plane, which is perpendicular to the axis of the first segment 201. The sensors 4 are oriented toward the tensioning assembly 203. For example, the posture adjustment device 204 may include three sensors 4, each spaced 120° apart around the first segment 201 and directed toward the pipeline region surrounding the tensioning assembly 203.

As a feasible embodiment, the posture adjustment device 204 of the above posture adjustment system further includes a movable-end mounting base 2044 and a fixed-end mounting base 2045. The universal joint includes a first-type and a second-type universal joint. The movable-end mounting base 2044 is fixed to the movable platform 2041 by bolts. The first-type universal joint is fixed to the movable-end mounting base 2044 by bolts. The first end of the linear actuator 2042 is connected to the first-type universal joint via bolts. The fixed-end mounting base 2045 is fixed to the fixed platform 2043 by bolts. The second-type universal joint is fixed to the fixed-end mounting base 2045 by bolts. The second end of the linear actuator 2042 is connected to the second-type universal joint via bolts.

As a feasible embodiment, the above-mentioned electrical control module includes a motion controller, a servo driver, and a servo motor. The motion controller is used to calculate the target posture of the first segment 201 based on the pipeline profile data and to execute inverse kinematics calculations on the target posture to generate a length variation signal for the linear actuator 2042. The servo driver generates a corresponding pulse signal based on the length variation signal issued by the motion controller. The servo motor rotates based on the pulse signal issued by the servo driver, thereby driving the corresponding linear actuator 2042 to perform telescopic motion until the first segment 201 reaches the target posture.

As shown in FIG. 18, in the integrated intelligent internal pipeline welding machine, the sensors 4 mounted on the first segment 201 detect the pipeline profile data and transmit it to the motion controller. The motion controller computes the telescopic length of each linear actuator 2042 in the posture adjustment device 204, thereby controlling the action of the movable platform 2041, and realizing active bending by the first segment 201 at the welding head of the internal welding machine.

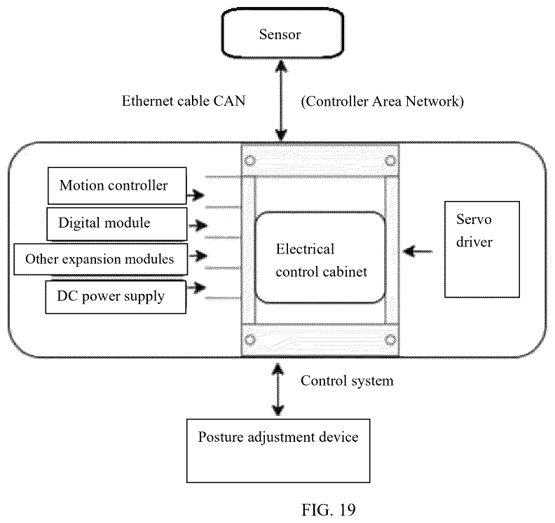

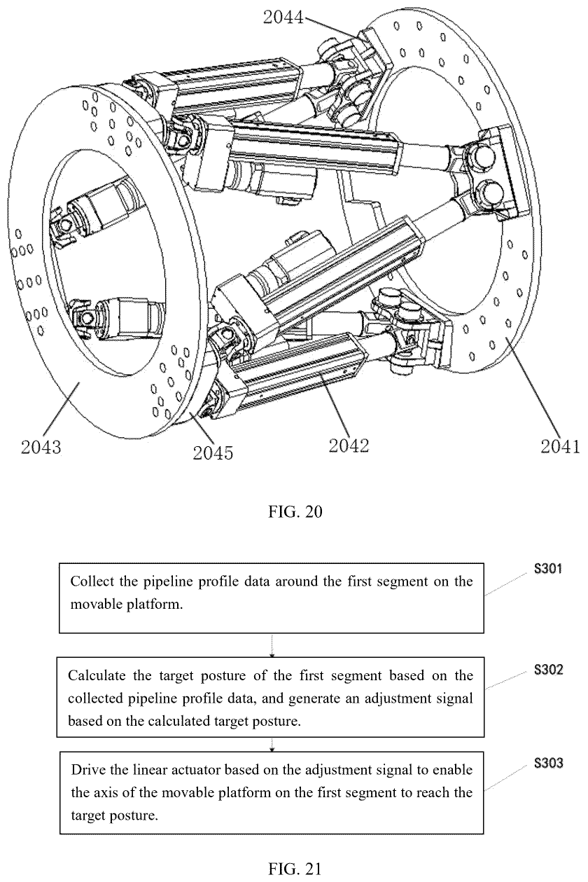

As shown in FIG. 19, a posture adjustment system includes sensors 4, an Ethernet cable, a controller area network (CAN), an electrical control cabinet, a motion controller, a digital module, other extension modules, a DC power supply, a servo driver, a control system, and a posture adjustment device 204. The posture adjustment device 204 may include a movable platform 2041, universal joints, a linear actuator 2042, and a fixed platform 2043, as shown in FIG. 20. The control system includes a control cabinet (which may be distributed on the internal pipeline welding machine), a multi-axis motion controller, a driver, and a servo motor.

The working principle of the posture adjustment device 204 is as follows: the sensor 4 detects the pipeline profile data and transmits it to the control system. The control system uses an inverse kinematics algorithm to convert the data into length variation signals for the linear actuator 2042. The motion controller then sends drive signals to the servo driver, which in turn drives the servo motor, enabling the linear actuator 2042 to perform telescopic motion based on the given length variation. The linear actuator 2042, through the mechanisms connected to the movable platform 2041 and the fixed platform 2043, drives the movable platform 2041 to adjust its position and posture, enabling the movable platform 2041 to follow the bending path of the pipeline.

FIG. 21 shows a flowchart of a posture adjustment method for an internal pipeline welding machine according to an embodiment of the present application, and the specific steps can include:
S301: Acquiring the pipeline profile data around the movable platform 2041 on the first segment 201 of the internal pipeline welding machine;

In conjunction with FIG. 18, the internal pipeline welding machine includes the first segment 201, the second segment 205, and the posture adjustment device 204. The first segment 201 is provided with a sensor 4 for detecting pipeline profile data in the vicinity of the movable platform 2041. In a preferred embodiment of certain systems, the posture adjustment device 204 is arranged between the cone assembly and the machine body mechanism; therefore, the movable platform 2041 is adjacent to the tensioning assembly 203. At this time, the sensor 4 detects the pipeline profile data near the tensioning assembly 203 and the welding device 202.

The posture adjustment device 204 is disposed between the first segment 201 and the second segment 205 of the internal pipeline welding machine. The posture adjustment device 204 includes a movable platform 2041, a fixed platform 2043, a linear actuator 2042, and universal joints. The movable platform 2041 is connected to the frame of the first segment 201, the fixed platform 2043 is connected to the frame of the second segment 205, and both ends of the linear actuator 2042 are pivotally connected to the movable platform 2041 and the fixed platform 2043, respectively.

In a preferred embodiment, the sensors 4 are stripe-type laser sensors. The laser stripes emitted by the sensor 4 are projected onto the pipeline, forming a laser profile line on the pipe surface. The image of the laser profile line is collected and analyzed to determine whether the sensors 4 currently detects the pipe end face.

More specifically, the traveling device on the second segment 205 drives it to move along the pipe toward the side where the first segment 201 is located. The position of the sensors 4 on the cone assembly is located ahead in the traveling direction relative to the tensioning assembly 203 and the welding device 202. In other words, the sensors 4 are farther from the second segment 205 than both the tensioning assembly 203 and the welding device 202. The emission direction of the laser stripe from the sensors 4 faces toward the side where the tensioning assembly 203 and welding device 202 are located. Furthermore, the emission direction of the laser stripe is inclined relative to the axial direction of the tensioning assembly 203 and oriented toward the radial outer side of the tensioning assembly 203. The lengthwise direction of the laser stripe lies in a plane that passes through the central axis of the tensioning assembly 203. Additionally, the laser stripe projection area of the sensors 4 covers the radial outer region directly facing the welding device 202, thereby ensuring that the position and posture of the first segment 201 can be detected in real time and precisely adjusted so that the welding device 202 is accurately aligned with the weld seam center between the two pipe ends.

The laser stripes emitted by the sensors 4 are projected onto the pipeline to form a laser profile line. When the position and posture of the first segment 201 relative to the pipeline vary, the laser stripe projected onto the pipeline will result in different shapes of laser profile lines. Specifically, different deflection states between the central axis of the tensioning assembly 203 on the first segment 201 and the central axis of the pipeline will result in different shapes of laser profile lines. For example, when the first segment 201 is located within a straight section of the pipeline and the central axis of the tensioning assembly 203 is completely aligned with the central axis of the pipeline, the laser stripe emitted by the sensors 4 forms a straight laser profile line on the inner wall of the pipeline. However, when there is a deflection angle between the central axis of the tensioning assembly 203 and the pipeline's central axis, the lengthwise direction of the laser stripe emitted by the sensors 4 becomes inclined relative to the axial direction of the pipeline, thereby forming a curved laser profile line on the inner wall of the pipeline.

More specifically, the laser profile lines formed by three sensors 4 are transmitted to the controller. The control system analyzes the images of the laser profile lines formed by each sensor 4 to derive corresponding control parameters. The posture adjustment device 204 operates according to the control parameters for concentric alignment, allowing the first segment 201 to remain aligned with the central axis of the tensioning assembly 203 and the pipeline's central axis, that is, the first segment 201 is maintained at the center of the pipe cross-section, ensuring that the internal pipeline welding machine travels smoothly along the inner wall of the pipe.

The sensors 4 for detecting the profile data may also be implemented using laser range sensors or image sensors installed on the internal pipeline welding machine. In other possible embodiments, the sensors 4 may be installed on the cone assembly, or on part or all of the tensioning units of the tensioning assembly 203, or on part or all of the welding device 202, or nearby. Naturally, to ensure timely posture adjustment, it is preferable to place the sensors 4 in a position close to the forward traveling direction of the internal pipeline welding machine. Moreover, positioning the detection area of the sensors 4 near the tensioning units or the welding device 202 can better ensure the effectiveness of posture adjustment.

If the central axes of the evenly-distributed tensioning units and the welding device 202 deviate from the pipeline's central axis, different image sensors or laser ranging sensors will yield different detection feedback results. By monitoring the corresponding signal changes via the sensors, the internal pipeline welding machine can adjust its posture in real time, thereby achieving posture adjustment.
S302: Calculating the target posture of the first segment 201 based on the pipeline profile data, and generating an adjustment signal based on the target posture;

In conjunction with FIGS. 18-20, this step specifically includes:
Based on known sensor installation calibration factors, transforming each sensor 4's scanned profile data into corrected profile data in the coordinate system of the first segment 201;
Based on the corrected profile data, computing the current position and posture of the pipeline in the coordinate system of the first segment 201;
Solving the mathematical model of the pipeline to obtain the pipeline position and posture information of the current pipeline in the coordinate system of the first segment 201;
Acquiring the posture (i.e., the deflection angle relative to the first segment 201) and position (i.e., the offset relative to the first segment 201) between the pipeline and the first segment 201 are obtained, and generating an adjustment signal.

Furthermore, since the sensors 4 and the tensioning assembly 203 and the welding device 202 are separated along the axis of the pipeline, to ensure accuracy needs to calibrate the measurement error of the sensors 4. In this embodiment, the sensor installation correction coefficient is a homogeneous transformation matrix composed of the design dimensions of each installation structure and the actual measurement error of each sensor 4. By multiplying the profile data scanned by each sensor 4 by the corresponding homogeneous transformation matrix, the profile data from each sensor 4 can be converted to the coordinate system of the first segment 201.

Subsequently, in the coordinate system of the first segment 201, the pipeline profile data collected by each sensor 4 is transformed; then, using an optimal fitting algorithm based on the corrected profile data, the position and posture of the current pipeline in the coordinate system of the first segment 201 are calculated.

By solving the mathematical model of the pipeline using an optimization objective function based on the least squares method, the pipeline position and posture information in the coordinate system of the first segment 201 is obtained.
S303: Based on the adjustment signal, driving the linear actuator 2042 so that the axis of the movable platform 2041 on the first segment 201 assumes the target posture.

As shown in FIGS. 18-21, the posture adjustment device 204 provided in this embodiment is arranged between the first segment 201 and the second segment 205 of the internal pipeline welding machine. When the linear actuator 2042 of the posture adjustment device 204 extends or retracts, it can change the posture of the first segment 201. In the course of operation, the electrical control module of this embodiment calculates the target posture of the first segment 201 based on the pipeline profile data and performs inverse kinematics calculations to generate the length change signals for the linear actuator 2042. The linear actuator 2042 is then controlled to extend or retract according to these length change signals, so that the first segment 201 assumes the target posture. This embodiment enables the internal pipeline welding machine to automatically adjust its posture based on pipeline profile data, thereby improving welding quality.

In the ideal target posture, the central axis of the movable platform 2041 coincides with the central axis of the pipeline cross-section where it is located. At this time, the first segment 201 of the internal pipeline welding machine adapts to the pipe via the linear actuator 2042 during travel without causing collision or interference. In actual situations, it is impossible for the axis of the movable platform 2041 to completely coincide with the pipeline cross-section axis. In such cases, approximate coincidence or parallelism of these axes is also considered to fall within the scope of the target posture referred to in this application.

Furthermore, after the sensors 4 collect the pipeline profile data at the location of the internal pipeline welding machine, the following operations may also be performed: determine the pipeline type at the internal welding machine's location based on the pipeline profile data. If the pipeline type is a bent pipe, proceed to calculate the target posture of the first segment 201 based on the profile data, enabling real-time adaptation of the internal pipeline welding machine to the inner profile of the pipeline. If the pipeline type is a straight pipe, all linear actuators 2042 are controlled to extend to the same distance, keeping the internal pipeline welding machine stable during travel.

Based on the above system, the internal pipeline welding machine equipped with the posture adjustment system can further reduce its forward speed when it is determined that the current pipeline is a bent pipe, so as to enable smoother operation through bends and reduce impact.

Please refer to FIG. 20. FIG. 20 is a structural schematic diagram of the posture adjustment device 204 according to this embodiment. The figure shows a fixed platform 2043 (connected to the second segment 205 in FIG. 18), a fixed-end mounting base 2045, a universal joint, a linear actuator 2042, a movable-end mounting base 2044, and a movable platform 2041 (connected to the first segment 201 in FIG. 18). The central axis of the fixed platform 2043 is defined as the Z-axis (the axial direction of the internal pipeline welding machine), the horizontal direction perpendicular to the Z-axis is defined as the X-axis, and the vertical direction perpendicular to the X-axis is defined as the Y-axis. X, Y, and Z represent the coordinate axes of a Cartesian coordinate system; φDX denotes pitch, φDY denotes roll, and φZ denotes yaw.

The posture adjustment method of the above embodiment is supplemented as follows: the method includes:
collecting pipeline profile data by the sensors 4;
using sensor installation correction coefficients obtained by prior measurement to splice and transform the pipeline profile data collected by each sensor into the coordinate system of the first segment 201 (i.e., the overall pipeline profile point cloud data).

The sensor installation correction coefficient is a homogeneous transformation matrix composed of the design installation dimension of each structure and the actual installation error measurement value of each sensor 4. By multiplying the profile data scanned by each sensor 4 by the homogeneous transformation matrix, the profile data of each sensor can be converted into the coordinate system of the first segment 201. The specific process is as follows:

Assume that the pipeline profile data collected by one of the sensors 4 is A(xᵢ,yᵢ0). Based on the design installation dimensions and installation errors, a homogeneous transformation matrix

$${T}_{A} = [ \begin{matrix}Rot & p \\ 0 & 1\end{matrix} ]$$

is obtained: the rotation matrix Rot is composed of the angles between the coordinate axes of the sensor coordinate system and those of the first segment 201 coordinate system, representing the rotational transformation; the vector p is composed of the coordinate values of the origin of the sensor coordinate system in the coordinate system of the first segment 201, representing the translational transformation.

The spliced pipeline profile data is expressed as:

$$P ( {x}_{i} , {y}_{i} , {z}_{i} ) = [ \begin{matrix}A & B & C & …\end{matrix} ] \cdot [ \begin{matrix}{T}_{A} \\ {T}_{B} \\ {T}_{C} \\ ⋮\end{matrix} ]$$

Where P(xᵢ,yᵢ,zᵢ) represents the overall pipeline profile data; A, B, C . . . represent the pipeline profile data collected by each sensor 4, T_{A}, T_{B}, T_{C} . . . correspond to a homogeneous transformation matrix; xᵢ represents the X-axis coordinate of the i-th point in the pipeline profile data, yᵢ represents the Y-axis coordinate, and zᵢ represents the Z-axis coordinate.

The process of solving the corrected profile data using a least squares optimization objective function to obtain the current pipeline position and posture information in the coordinate system of the first segment 201 is as follows:

The overall pipeline profile data is P(xᵢ,yᵢ,zᵢ), where i=1, 2, . . . , n, let n be the number of points in the pipeline profile data; a point P₀ on the pipeline axis can be represented as (x₀,y₀,z₀) or as P₀(x₀,y₀,z₀), x₀ denotes an x-axis coordinate of a point on the pipeline axis, y₀ denotes a y-axis coordinate of the point on the pipeline axis, z₀ denotes a z-axis coordinate of the point on the pipeline axis, V represents the pipeline axis vector, which can also be expressed as V(a,b,c), a represents the coordinate of the axial vector V of the pipeline on the x-axis, b represents the coordinate of the axial vector V of the pipeline on the y-axis, c represents the coordinate of the axial vector V of the pipeline on the z-axis, Rᵢ represents the distance from a point in the profile point cloud data Pᵢ(xᵢ,yᵢzᵢ) to the pipeline axis. The mathematical description of the pipeline (i.e., the pipeline mathematical model) is expressed as follows:

$${[ c ( {y}_{i} - {y}_{0} ) - b ( {z}_{i} - {z}_{0} ) ]}^{2} + {[ a ( {z}_{i} - {z}_{0} ) - c ( {x}_{i} - {x}_{0} ) ]}^{2} + {[ b ( {x}_{i} - {x}_{0} ) - a ( {y}_{i} - {y}_{0} ) ]}^{2} = {R}_{i}^{2}$$

In this embodiment, the following formula is used as the optimization objective function F(X), where R denotes the pipeline radius:

$$F ( X ) = \frac{1}{2} {\sum }_{i = 1}^{n} {( R - {R}_{i} )}^{2}$$

Solving for the pipeline position and posture parameters P₀(x₀,y₀,z₀) and V(a,b,c) and R is converted into solving for the extremum point X at which F(X) reaches a minimum, where X=[P₀,V,R].

Therefore, this nonlinear optimization problem is transformed into the problem of minimizing F(X) to solve for X, expressed as:

$$X = arg {min}_{X} F ( X )$$

X represents a point on the pipeline axis which is P₀(x₀,y₀,z₀) in the parameters in the mathematical model of the pipeline, V(a,b,c) represents the axial vector of the pipeline, R represents the vector composed of the pipeline radius. That is X=[x₀;y₀;z₀;a;b;c;R].

To solve this nonlinear optimization problem, the embodiment linearizes the nonlinear function, constructs a Jacobian matrix, and uses singular value decomposition to iteratively solve the parameter values in the nonlinear equations of the pipeline mathematical model.

The process of solving A specifically includes:

Step 1: Setting the initial value \hat{x}=[\hat{P}₀,\hat{V},\hat{R}] of the pipeline position, where \hat{P}₀=[\hat{x}₀,ŷ₀,\hat{z}₀] and \hat{V}₀=[â,\hat{b},ĉ]. \hat{P}₀ is the estimated coordinate of a point on the pipeline axis (in this embodiment, pipeline offset can be represented by the coordinate value of a point on the axis). \hat{x}₀ represents the estimated coordinate of a point P₀ of the pipeline on the a-axis, ŷ₀ represents the estimated coordinate of a point P₀ of the pipeline on the y-axis, \hat{z}₀ represents the estimated coordinate of a point P₀ of the pipeline on the z-axis. \hat{V} represents the estimated value of the pipeline axis vector (in this embodiment, the pipeline deflection angle can be represented by the pipeline axis vector); â represents the estimated coordinate of the pipeline axis vector V along the X-axis; \hat{b} represents the estimated coordinate of the pipeline axis vector V along the Y-axis; ĉ represents the estimated coordinate of the pipeline axis vector V along the Z-axis; \hat{R} represents the estimated value of the pipeline radius.

Step 2: During the optimization iteration, in order to reduce the computational complexity of F(X) derivation, a Cartesian coordinate system is established with the origin at \hat{P}₀ and \hat{V} as the Z-axis. The homogeneous transformation matrix U is used to transform the pipeline profile data Pᵢ(xᵢ,yᵢ,zᵢ) into this coordinate system, therefore, at this time â=0, \hat{b}=0, ĉ=1, \hat{x}₀=0, ŷ₀=0, \hat{z}₀=0. By taking these constants into F(X), deriving F(X) with respect to \hat{X}, and by setting the derivative function to zero, the following system of linear equations is obtained:

$$Jac \cdot Δ X = \frac{1}{2} D$$

Where Jac is the Jacobian matrix obtained by taking partial derivatives of the independent variables of F(X):

$$Jac = [ \begin{matrix}{x}_{1} {z}_{1} / {R}_{1} & {y}_{1} {z}_{1} / {R}_{1} & {x}_{1} / {R}_{1} & {y}_{1} / {R}_{1} & 1 \\ {x}_{2} {z}_{2} / {R}_{2} & {y}_{2} {z}_{2} / {R}_{2} & {x}_{2} / {R}_{2} & {y}_{2} / {R}_{2} & 1 \\ ⋮ & ⋮ & ⋮ & ⋮ & ⋮ \\ {x}_{n} {z}_{n} / {R}_{n} & {y}_{n} {z}_{n} / {R}_{n} & {x}_{n} / {R}_{n} & {y}_{n} / {R}_{n} & 1\end{matrix} ]$$

and the vector D used for representing fitting error is

$$D = [ \begin{matrix}R - {R}_{1} \\ R - {R}_{2} \\ ⋮ \\ R - {R}_{n}\end{matrix} ] .$$

Since

$$Jac \cdot Δ X = \frac{1}{2} D$$

is an overdetermined equation and the vector D does not lie in the column space of Jac, singular value decomposition is used to solve for ΔX. The step size ΔX in the iteration is expressed by the following formula, Δa, Δb, Δx, Δy and ΔR are the coefficients of the projection vector of the linearly expressed vector D onto the column space of Jac:

$$Δ X = [ \begin{matrix}Δ a \\ Δ b \\ Δ x \\ Δ y \\ Δ R\end{matrix} ]$$

Step 3: Solving the above linear system to obtain the matrix ΔX and update the iteration parameters. T denotes the transpose operation.

$$\hat{V} = [ \begin{matrix}Δ a \\ Δ b \\ 1\end{matrix} ] {U}^{T}$$

$${\hat{P}}_{0} = {\hat{P}}_{0} + [ \begin{matrix}Δ x \\ Δ y \\ - ( Δ a Δ x + Δ b Δ y )\end{matrix} ] {U}^{T}$$

$$\hat{R} = \hat{R} + Δ R$$

Step 4: Determining whether the norm of ΔX is less than the required accuracy for the iteration. If not, return to Step 2 to continue the iteration; if so, stop the iteration and output the result X=[\hat{P}₀,\hat{V},\hat{R}]. The solved value X contains the pipeline position and posture information, including the posture (i.e., deflection angle relative to the first segment 201) and position (i.e., offset relative to the first segment 201) between the pipeline and the first segment 201. The posture and position are transmitted to the multi-degree-of-freedom adjustment mechanism (e.g., a six-degree-of-freedom motion platform), ensuring that the axis of the first segment 201 always coincides with the axis of the pipeline. As the internal welding machine advances through the pipeline, this enables the first segment 201 to smoothly adapt to motion through curved sections.

The posture adjustment device 204 (preferably implemented as a six-degree-of-freedom motion platform in the preferred embodiment) may also, after obtaining the target posture, first analyze the workspace of the posture adjustment device 204 to determine whether the target posture lies within its operable workspace of the posture adjustment device 204. If not, an execution error is triggered, and the target posture is modified to the closest value within the executable workspace range. Combined with robotic inverse kinematics and trajectory curve constraints, the extension amounts of each electric cylinder in the six-degree-of-freedom motion platform are generated, and these values are transmitted in real time to the motor drivers of the cylinders via network communication. The drivers use triple-loop PID control to rotate the motors. At the same time, each motor driver reports the current extension of each axis to the communication master station, which uses robotic forward kinematics to calculate and report the actual position and posture of the movable platform to the trajectory planner, allowing real-time adjustment of the planned posture and improving the control accuracy of the multi-degree-of-freedom adjustment mechanism.

In the preferred embodiment described above, the second segment 205 is the machine body of the internal pipeline welding machine. The fixed platform 2043 and the machine frame of the internal pipeline welding machine are integrally designed, meaning the fixed platform 2043 is a part of the machine frame. When the machine body moves, the fixed platform 2043 also moves accordingly. Mounting holes are provided on the fixed platform 2043. The fixed-end mounting base 2045 is bolted to the fixed platform 2043. The universal joint is bolted to the fixed-end mounting base 2045. The linear actuator 2042 is bolted to the universal joint.

Correspondingly, in this embodiment, the first segment 201 is a cone assembly. The movable platform 2041 and the frame of the cone assembly of the internal pipeline welding machine are integrally designed, meaning the movable platform 2041 is part of the frame of the cone assembly. When the movable platform 2041 moves, the cone assembly also moves accordingly. Mounting holes are provided on the movable platform 2041. The movable-end mounting base 2044 is bolted to the movable platform 2041. The linear actuator 2042 is bolted to the movable-end mounting base 2044.

With the above structure, when the position and posture of the movable platform 2041 changes relative to the fixed platform 2043, the position and posture of the first segment 201 relative to the second segment 205 also changes. This allows the internal pipeline welding machine to automatically turn under the control of the system when encountering a curved pipe.

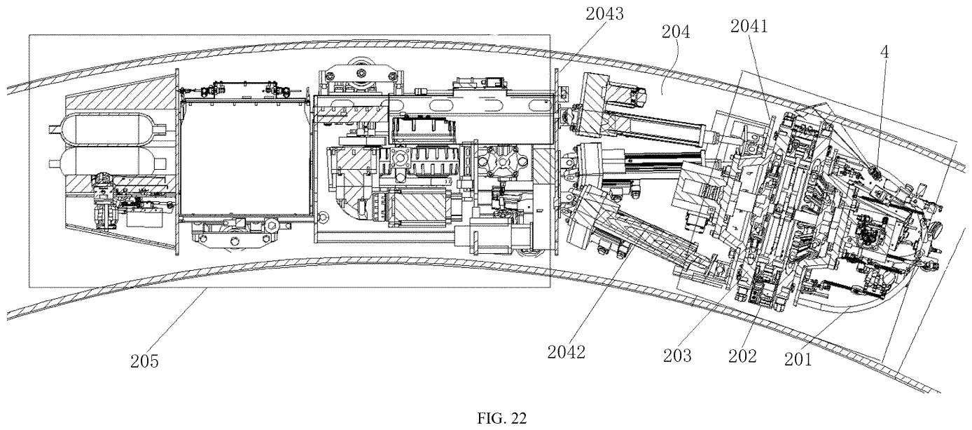

Please refer to FIG. 22. FIG. 22 is a structural schematic diagram of an internal pipeline welding machine navigating a bend, provided in this embodiment. The figure shows the second segment 205, the posture adjustment device 204, the tensioning assembly 203, the first segment 201, the sensor 4, the movable platform 2041, the linear actuator 2042, the fixed platform 2043, and the pipeline.

Each linear actuator 2042 in the posture adjustment device 204 can individually perform telescopic motion in space. By controlling the extension amount of the linear actuators 2042, the control system can control the movable platform 2041 to achieve six degrees of freedom of motion in space, thereby changing the position and posture of the movable platform 2041 and enabling the internal pipeline welding machine to navigate bends. The six degrees of freedom refer to translational motion along the X, Y, and Z coordinate axes, and rotational motion around the three coordinate axes (pitch φX, roll φDY, yaw φZ).

Based on the motion state of the movable platform 2041, the response position and velocity command signals for each linear actuator 2042 are calculated. This controls the motion of the movable platform 2041, ensuring it moves along a predetermined trajectory. When the movable platform 2041 reaches the required position, the velocity command signals to all the linear actuators 2042 are set to zero, and the movable platform 2041 stops, achieving precise position control. The internal pipeline welding machine moves forward and backward under the action of its traveling mechanism. When it encounters a bent pipe, based on data input from the sensors 4, the distance each linear actuator 2042 needs to act is computed, so that the movable platform 2041 moves to a suitable position and avoids colliding with the inner wall of the pipeline while going through the bend. When the internal pipeline welding machine is traveling in a straight pipe section, the movable platform 2041 is parallel to the fixed platform 2043, and all its linear actuators 2042 extend by the same distance. Its initial posture is as shown in FIG. 18. When the internal pipeline welding machine goes through a bend (for example, a downward bend), the movable platform 2041 will rotate relative to the fixed platform 2043, and its posture is as shown in FIG. 22.

In order to improve the real-time performance, high-speed response, and efficiency of the control system, the controller analyzed the functions of each control module and, considering the real-time requirements of each function in the control system, adopted the following overall design scheme for the platform control system:

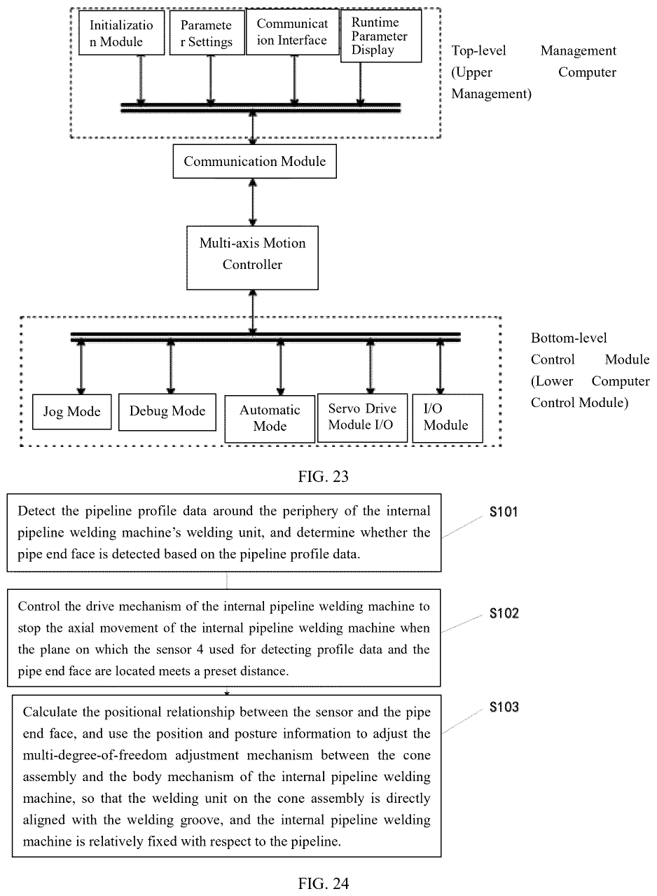

Please refer to FIG. 23. FIG. 23 is an overall design diagram of a control system provided in this embodiment. The diagram shows a system including a host computer management module (which includes an initialization module, a parameter setting module, a communication module, and an operation parameter display), a communication interface, a multi-axis motion controller, and a lower-computer control module (which includes an electric mode, a test mode, an automatic mode, a servo drive module, and an I/O module).

In this embodiment, the real-time module, i.e. the platform control system, has very high real-time requirements. It mainly includes: a position servo module, a servo drive module, and a fault detection module. During operation of the platform, the position servo module performs precise position control for each axis, which determines whether the actuators can successfully complete the corresponding motion trajectories. The servo drive module monitors and controls the operating state of each axis and handles the switching of each axis's operating state. The fault detection module monitors the operating status of each axis and its actuators, and when a fault occurs, it immediately stops the platform's movement, thereby protecting personnel safety and preventing damage to the platform.

The control system can also perform a rationality analysis on tasks based on user input parameters, and it has the function of blocking control commands that exceed the allowed motion range. The control system has reasonable settings and monitoring for the ranges of motion parameters such as the platform's maximum speed and maximum acceleration. If it is found that the user's input command is not reasonable, the movable platform will execute the motion within the preset safe maximum motion parameters to complete continuous motion control, and it will also issue an alarm warning.

Since the method embodiments correspond to the device embodiments, the descriptions of the method embodiments are referred to the descriptions of the device embodiments and will not be redundantly described here.

The present application also provides a storage medium on which a computer program is stored. When the computer program is executed, it can perform the steps provided in the above embodiment. The storage medium may include: a USB flash drive, a mobile hard disk, a read-only memory (ROM), a random access memory (RAM), a magnetic disk or an optical disc, and any other medium that can store program code.

The present application further provides an internal pipeline welding machine, which includes: a first segment 201, a second segment 205, and a posture adjustment system.

The posture adjustment system includes a posture adjusting device 204, an electrical control module, and a sensor 4;

the posture adjusting device 204 is arranged between the first segment 201 and the second segment 205; the posture adjusting device 204 includes a movable platform 2041, a fixed platform 2043, linear actuators 2042, and a universal joint. The movable platform 2041 and the frame of the first segment 201 are integrated into a single structure, and the fixed platform 2043 and the frame of the second segment 205 are integrated into a single structure. The two ends of each linear actuator 2042 are connected to the movable platform 2041 and the fixed platform 2043 respectively via the universal joint;

The sensor 4 is used to collect pipeline profile data at the position of the internal welding machine.

The electrical control module is used to calculate the target posture of the first segment 201 based on the pipeline profile data and to perform an inverse kinematics calculation to generate a length-change signal for the linear actuator 2042. The electrical control module is further used to control the linear actuator 2042 to extend or retract according to the length-change signal, so that the first segment 201 is brought to the target posture.

### Alignment Method of Internal Pipeline Welding Machine

FIG. 24 is a flowchart of an internal pipeline welding machine alignment method provided by this embodiment. The specific steps can include:
S101: Detect the pipeline profile data around the periphery of the internal pipeline welding machine's welding unit 304, and determine whether the pipe end face is detected based on the pipeline profile data.

In this embodiment, the method can be applied to an internal pipeline welding machine equipped with the sensor 4 and the multi-degree-of-freedom adjusting mechanism 303. The internal pipeline welding machine can further include a cone assembly 301 and a body mechanism 302. Specifically, the sensor 4 may be disposed on the outer surface of the cone assembly 301. The multi-degree-of-freedom adjusting mechanism 303 may be arranged between the cone assembly 301 and the body mechanism 302. The cone assembly 301 can be provided with a welding unit 304, tensioning shoes 305, and a tensioning device 306.

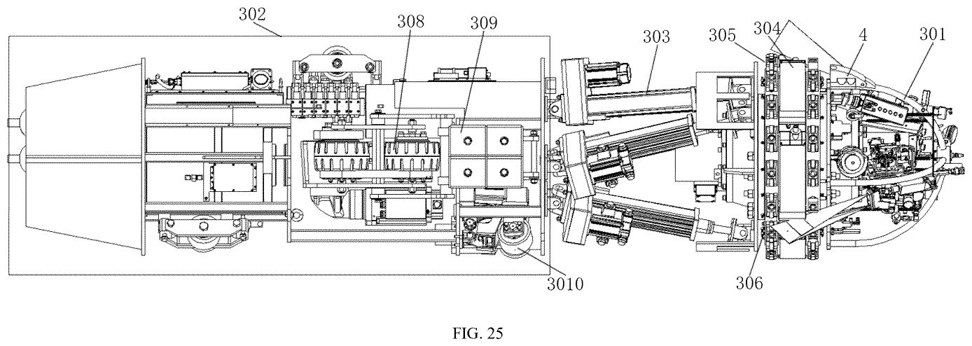

Referring to FIG. 25, FIG. 25 is a schematic structural diagram of an internal pipeline welding machine according to this embodiment. It shows the cone assembly 301, the sensor 4, the multi-degree-of-freedom adjusting mechanism 303, the welding unit 304, the tensioning shoes 305, the tensioning device 306, and the body mechanism 302. The body mechanism 302 includes a traveling device 308, a braking device 309, and a flexible front wheel 3010.

In this embodiment, multiple sensors 4 can be arranged on the cone assembly 301 to allow each sensor 4 to acquire profile data of the pipe wall corresponding to the peripheral area around the internal welding machine's welding unit 304. This includes profile data of the pipe's inner wall and/or profile data of the end grooves of the pipeline.

In a preferred embodiment, the sensors 4 are stripe-type laser displacement sensors. The laser stripes emitted by the sensors are projected onto the pipeline, thereby forming a laser profile line on the pipeline. By capturing and analyzing images of the laser profile line, it is possible to determine whether the sensors 4 have detected the pipe end face.

More specifically, the traveling device 308 on the body mechanism 302 drives the body mechanism 302 to move along the pipeline toward the side where the cone assembly 301 is located. The position of the sensor 4 on the cone assembly 301 is located ahead of the tensioning device 306 and the welding unit 304 in the direction of travel. In other words, the sensor 4 is positioned further away from the body mechanism 302 relative to the tensioning device 306 and the welding unit 304. The emission direction of the laser stripes from the sensors 4 faces the side where the tensioning shoes 305 and the welding unit 304 are located. The emission direction of the laser stripes is inclined relative to the axial direction of the tensioning device 306 and oriented radially outward the tensioning device 306. The longitudinal direction of the laser stripes lies in a plane that passes through the central axis of the tensioning device 306. Furthermore, the laser projection region of sensor 4 covers the radially outer area directly opposite the welding unit 304, thereby ensuring real-time detection and precise adjustment of the position and posture of the cone assembly 301 so that the welding unit 304 is accurately aligned with the center of the weld seam between the two pipe ends.

The laser stripes emitted by the sensors 4 are projected onto the pipeline to form a laser profile line. When the position and posture of the cone assembly 301 relative to the pipeline change, the laser profile line formed on the pipeline also changes in shape. Specifically, when the central axis of the tensioning device 306 on the cone assembly 301 deviates from the central axis of the pipeline, different shapes of laser profile lines are formed. For example, when the cone assembly 301 is in a straight pipe section and the central axis of the tensioning device 306 coincides completely with that of the pipeline, the laser stripes emitted by the sensor 4 form a straight profile line on the inner wall of the pipe. However, if the central axis of the tensioning device 306 and the pipeline axis have a deviation angle, the longitudinal direction of the laser stripes emitted by the sensors 4 will be inclined relative to the pipe axis, thus forming a curved laser profile line on the inner wall of the pipe. In addition, the real-time laser profile image collected by the sensors 4 can be matched against a preset groove profile image to recognize the grooves for alignment purposes.

In a preferred embodiment of this method, three sensors 4 are preferably used and are evenly distributed circumferentially. When the laser image from the sensors 4 changes into an L-shape in the previous step, it is determined whether the sensors 4 have detected the pipe groove end face based on whether the detected laser profile image matches the preset profile image. Specifically, the profile data from each sensor 4 is proportionally downsampled and converted into a binary profile image. This profile image is then matched with a preset groove profile image (such as a standardized groove image). If the profile image matches the pre-stored groove profile image (e.g., if the similarity is greater than a preset threshold), it can be determined that a groove has been detected.

More specifically, the laser profile lines generated by the three sensors 4 are transmitted to the controller. The controller analyzes the profile images from each sensor 4 to obtain the corresponding control parameters. The multi-degree-of-freedom adjusting mechanism 303 then acts according to the control parameters that maintain coaxiality with the pipeline, thereby keeping the cone assembly 301 in a state where the central axis of the tensioning device 306 coincides with the central axis of the pipeline. In other words, the cone assembly 301 is kept at the geometric center of the pipe cross-section, ensuring that the internal pipeline welding machine can travel smoothly along the inner wall of the pipeline.

At the same time, different shapes of laser profile lines will be formed depending on the position of the cone assembly 301 relative to the pipe end. Taking the scenario where the internal pipeline welding machine's cone assembly 301 maintains the state in which the central axis of the tensioning device 306 is aligned with the central axis of the pipeline while moving along the pipeline as an example: when the cone assembly 301 is entirely located within a straight section of the pipeline, or when the tensioning device 306 and the welding unit 304 are still fully within a straight pipe segment, the laser stripes emitted by the sensors 4 are projected only onto the inner wall of the pipe, resulting in a straight laser profile line. However, as the internal pipeline welding machine continues to move forward and the laser stripes emitted by the sensors 4 are projected onto the groove of the pipe end, the resulting laser profile line takes on an approximate L-shape, indicating a change in the shape of the laser profile line. By analyzing and processing the image of the laser profile line, it is possible to determine the positional status of the cone assembly 301 of the internal pipeline welding machine relative to the pipe end. This can be done by matching and comparing the real-time laser profile image acquired by the sensors 4 with a preset profile image (the preset profile image may specifically be a standard laser profile image formed when the laser stripes are projected onto the pipe end). In this way, it can be determined whether the sensors 4 have scanned and detected the pipe end, i.e., the distance between the cone assembly 301 and the pipe end can be obtained. Based on this, the traveling system can be automatically controlled to stop, and an output parameter can be used to control the multi-degree-of-freedom posture adjustment mechanism to adjust the position and posture of the cone assembly, so that the welding unit 304 in the internal pipeline welding machine's cone assembly 301 is roughly positioned within the groove region 3012.
S102: Control the internal pipeline welding machine's drive mechanism to stop the axial movement of the internal pipeline welding machine when the plane on which the sensor 4 used for detecting profile data and the pipe end face are located meets a preset distance.

The target stop position is determined based on the pipeline profile data, so that when the internal pipeline welding machine moves to the target stop position, the welding unit 304 within the cone assembly 301 is positioned inside the groove region 3012 (i.e., the area where the pipe groove is located). After determining the target stop position, the traveling device 308 of the internal pipeline welding machine can be controlled to stop moving, thereby roughly positioning the welding unit 304 and the tensioning shoes 305 of the internal pipeline welding machine near the pipe groove.

To improve accuracy and avoid interference in the sensor detection images caused by protrusions on the inner surface of the pipe, when the number of sensors 4 detecting the pipe end face is greater than one, it is determined that the tensioning shoes 305 of the internal pipeline welding machine are essentially located within the groove region 3012.

When the number of sensors 4 involved in image matching is greater than one, it can be determined that multiple sensors 4 have detected the groove. At this point, due to factors such as signal processing delays, inertia, and/or preset control procedures of the system, the internal pipeline welding machine continues to move a certain distance within the pipeline. During the process of detecting the pipe end groove and verifying that the plane on which the sensors 4 are located meets the preset distance condition relative to the pipe end face, the system also processes the pipeline profile data to obtain the relative position between the pipeline profile and the cone assembly 301. That is, during image matching, the system can first determine the approximate translation and rotation values of the groove shape in the profile image, thereby adjusting the multi-degree-of-freedom platform so that the plane on which the welding unit 304 is located is approximately coplanar with the plane of the groove, and the central axis of the welding unit 304 is approximately coaxial with the central axis of the surrounding pipeline. If the welding unit 304 is already located at the pipe groove at this point, its central axis is approximately coaxial with that of the groove. That is, at the beginning of corner point detection and optimal fitting of the groove profile shape, the matched groove template image is already approximately centered within the profile image, and the position and posture of the cone assembly 301 is adjusted by the multi-degree-of-freedom posture adjustment mechanism through output parameters. In this way, the multi-degree-of-freedom platform can not only achieve alignment but also adjust the position and posture of the internal pipeline welding machine relative to the pipeline prior to alignment. When the axis of the internal pipeline welding machine is approximately colinear with the axis of the pipeline segment in which it is located, the traveling system is automatically controlled to stop, positioning the welding unit 304 within the cone assembly 301 approximately in the groove region 3012. For deviations that may occur during the movement of the internal pipeline welding machine or those caused by navigating curved pipeline sections, performing posture adjustment in advance enables more accurate and efficient alignment.

When the positional relationship between the sensors 4 and the plane of the pipeline end face reaches a preset distance condition, fine adjustment of the alignment position is further performed by the multi-degree-of-freedom adjustment mechanism 303.

In other embodiments of the present application, whether the plane on which the sensors 4 that detect profile data and the pipe end face are located satisfies a preset distance condition can also be determined using laser range sensors, image sensors, flux sensors, or other methods installed on the internal pipeline welding machine. In other possible embodiments, the sensors 4 may be installed on the cone assembly 301, on the tensioning shoes 305 of the tensioning device 306, on or near the welding unit 304, or on the body mechanism 302. When the sensors are located on or near the tensioning shoes 305 or welding unit 304, if the tensioning shoes 305 or the welding unit 304 happen to extend into the groove region 3012 of the pipeline, the distance, image, light flux, or magnetic flux (in the case of a metal pipeline) between them and the inner wall of the pipeline will change. By detecting the corresponding signal changes through the sensors 4, the internal pipeline welding machine is stopped from further axial movement within the pipeline, ensuring that sensors 4 and the pipe end face are located in planes that satisfy the required distance condition.

Due to the large size and heavy weight of the internal pipeline welding machine, alignment cannot be accurately achieved solely by driving the internal pipeline welding machine using the traveling device 308. Therefore, in each of the above embodiments, the internal pipeline welding machine is first brought to a smooth stop inside the pipeline with the tensioning shoes 305 approximately positioned within the welding region. Then, fine adjustment is performed through the following steps to achieve automated alignment:
S103: Calculate the positional relationship between the sensors 4 and the pipe end face, and using the position and posture information to adjust the multi-degree-of-freedom adjustment mechanism 303 between the cone assembly 301 and the body mechanism 302 of the internal pipeline welding machine, such that the welding unit 304 on the cone assembly 301 is directly aligned with the welding groove, and the internal pipeline welding machine is relatively fixed with respect to the pipeline.

After the internal pipeline welding machine moves to the target stop position, the positional relationship between the sensors 4 and the pipe end face can be calculated from the pipeline profile data. Specifically, corner detection can be performed on the obtained profile image of the pipeline; the coarse coordinate values of each vertex in the profile image are obtained, and these coarse coordinate values are used as initial values to perform multi-segment polyline fitting on the profile data, thereby obtaining the precise coordinates of each vertex. The precise coordinates of each profile vertex are then converted into the spatial feature coordinates of the groove in the coordinate system of the cone assembly 301, thereby determining the position and posture information of the pipe groove within the coordinate system of the cone assembly 301. This position and posture information includes the angular deviation and offset data between the roove and the cone assembly 301. Based on this position and posture information, the multi-degree-of-freedom adjustment mechanism 303 between the cone assembly 301 and the body mechanism 302 of the internal pipeline welding machine is adjusted. By adjusting the extension of one or more electric cylinders in the multi-degree-of-freedom adjustment mechanism 303, the welding torch in the welding unit 304 on the cone assembly 301 is aligned with the groove. After the position and posture of the cone assembly 301 is adjusted, the tensioning device 306 is extended to fix the internal pipeline welding machine relative to the pipeline.

The coordinate system of the cone assembly 301 refers to the coordinate system of the cone assembly itself. The pipe groove refers to the portion of the pipeline to be welded.

Since the internal pipeline welding machine is typically used in scenarios where the pipeline diameter is large and the weld region formed by the grooves of two joined pipes is narrow, even slight deviations in the internal pipeline welding machine's travel within the pipe may prevent accurate alignment of the pipe ends.

After determining the groove position and posture information, this information can be input into the multi-degree-of-freedom adjustment mechanism 303, which is then used to adjust the position and posture of the cone assembly 301 so that the welding torch in the welding unit 304 on the cone assembly 301 is directed precisely at the center of the weld seam of the pipe grooves.

Further, the multi-degree-of-freedom adjustment mechanism 303 is a six-degree-of-freedom motion platform composed of multiple electric cylinders. Accordingly, the position and posture of the cone assembly 301 can be adjusted as follows: the groove position and posture information are input into the multi-degree-of-freedom adjustment mechanism 303, which adjusts the extension of one or more electric cylinders based on the groove position and posture information to control the position and posture of the cone assembly 301.

After the position and posture adjustment is complete, the tensioning shoes 305 expand to press against the inner circumference of the pipe, thereby fixing the welding unit 304 relative to the inner wall of the pipe.

After the welding torch of the welding unit 304 is aligned with the center of the weld seam of the pipe groove, the tensioning shoes 305 located within the pipeline expand to press against the inner wall. Once the other pipe to be welded is docked from one side of the cone assembly 301, the tensioning shoes 305 on the other side extend and expand, completing the alignment process. In other embodiments in the field, after the welding torch of the welding unit 304 is aligned with the center of the weld seam of the pipe grooves, the other pipe to be welded can first be roughly aligned with the pipe groove, and then the two sets of tensioning shoes 305 are sequentially or simultaneously expanded against the inner wall of the pipe. At this point, the six-degree-of-freedom platform may also be used to adjust the interface gap between the two pipes to meet welding requirements.

In this way, the welding torch of the welding unit 304 in the internal welding machine can be automatically adjusted to be directly aligned with the center of the weld seam of the pipe grooves in this alignment scenario, thereby enabling the internal pipeline welding machine to achieve high-precision automated alignment and improving the welding quality.

More specifically, the precise coordinates of each profile vertex can be determined as follows: using the corner point coordinates as initial values to construct a mathematical model of the groove profile corresponding to the profile data; then solving the profile mathematical model using a least squares optimization objective function to obtain the precise coordinates of each profile vertex.

As another embodiment corresponding to FIG. 24, the working scenario of the internal pipeline welding machine can also be determined via the sensors 4. If the current working scenario is a positioning scenario, the internal pipeline welding machine can also perform the following operations: perform stitching and coordinate transformation on the pipeline profile data collected by all sensors 4 based on sensor installation calibration parameters, thereby obtaining the overall pipeline profile data in the coordinate system of the cone assembly 301; determine the current pipeline's position and posture information in the coordinate system of the cone assembly 301 based on the overall pipeline profile data (wherein the current pipeline refers to the pipeline corresponding to the pipeline profile data); then use the multi-degree-of-freedom adjustment mechanism 303 to adjust the position and posture of the cone assembly 301 based on the pipeline position and posture information, so that the axis of the cone assembly 301 coincides with the axis of the current pipeline. The above-mentioned overall pipeline profile data is the result of stitching the pipeline profile data collected by the respective sensors 4, and is used to describe the overall shape of the inner wall profile of the pipeline.

Specifically, if the internal pipeline welding machine is equipped with M sensors 4, the current working scenario of the internal pipeline welding machine can be determined as follows: use the M sensors 4 to acquire pipeline profile data and generate a binarized profile image corresponding to the pipeline profile data collected by each sensor 4; match each binarized profile image with a preset groove profile image; if the number of successfully matched binarized profile images is greater than or equal to N, then the current working scenario of the internal pipeline welding machine is determined to be the alignment scenario; if the number of successfully matched binarized profile images is less than N, then the current working scenario of the internal pipeline welding machine is determined to be the positioning scenario, i.e., the scenario of traveling axially along the pipeline, wherein 0<N≤M.

In this process, matching is performed between the binarized profile images and the preset groove profile image. If the similarity between part or all of the binarized profile image and the preset groove profile image exceeds a preset similarity threshold (e.g., 90%), the binarized profile image is deemed a successful match. This embodiment determines whether the current working scenario is the alignment scenario or the positioning scenario based on the number of successfully matched binarized profile images. To improve the detection accuracy of the working scenario, N can be set equal to M to avoid interference caused by localized protrusions on the inner wall of the pipeline. As a feasible implementation, this embodiment can have M (e.g., M=3) sensors 4 evenly distributed on the cone assembly 301 to enhance the comprehensiveness of the pipeline profile data acquisition.

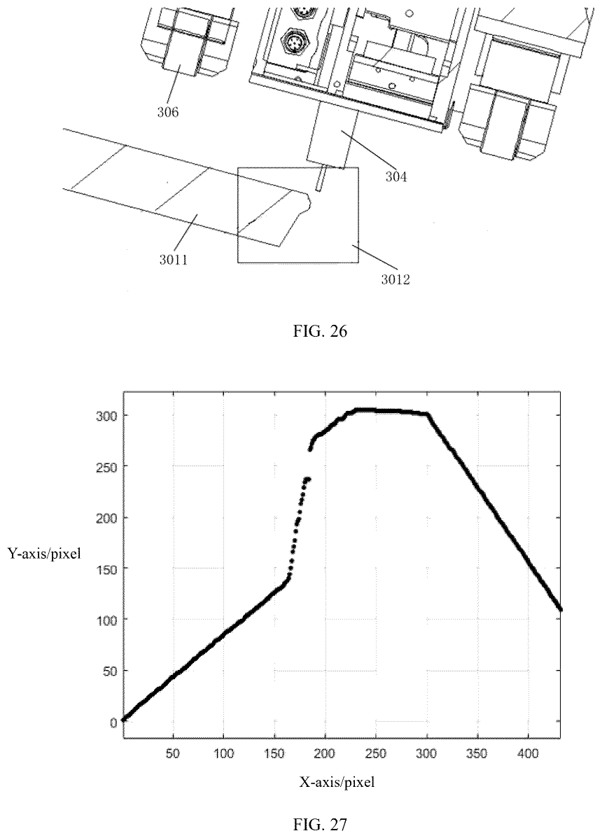

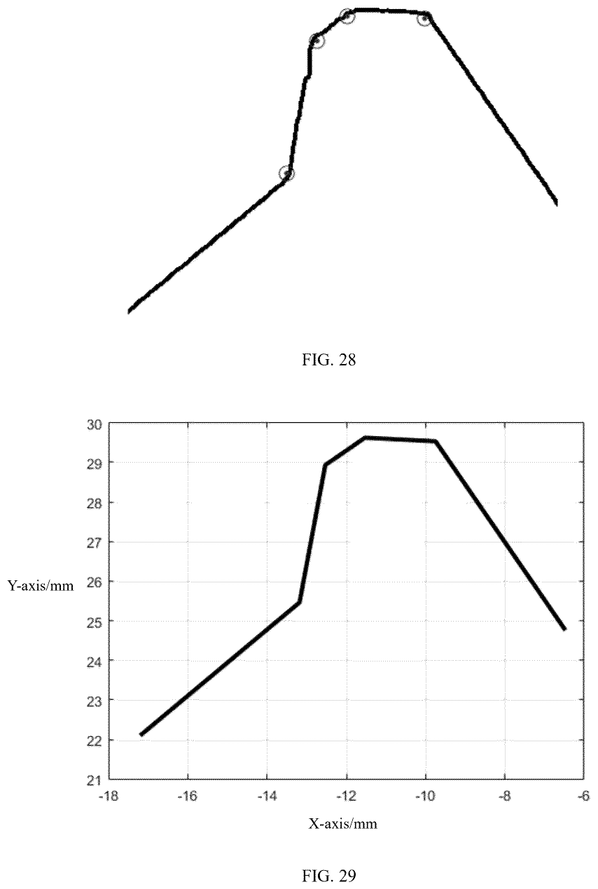

The following illustrates the above-described process using an actual application scenario with reference to FIGS. 26-29. FIG. 26 is a schematic partial enlargement of the welding unit 304 and the groove during the alignment process provided in this application embodiment; FIG. 27 is a schematic diagram showing how groove profile data collected by a sensor is downsampled and converted into an image; FIG. 28 is a schematic diagram of the result of corner detection performed on a groove profile; and FIG. 29 is a schematic diagram of a groove profile fitting result.

FIG. 26 shows the fixed steel pipe 3011, a groove region 3012, a welding unit 304, and a tensioning device 306. The multi-sensor acquisition system includes a stripe laser displacement sensor head, a sensor controller, and a network communication module. The alignment control process includes corner detection, optimal fitting of the groove profile, determination of sensor correction coefficients, stitching of groove feature points, calculation of groove position and posture, adjustment and control of the cone assembly system, control of the rear tensioning shoe 305 to engage, placement of the new pipe, and control of the front tensioning shoe 305 to engage.

In the related art, there are two main difficulties in pipe alignment for curved pipes: (1) during the groove shaping process for curved pipes, due to installation errors of the grooving machine, the groove cutting surface is inevitably not perpendicular to the pipeline axis; (2) during internal alignment in curved pipes, the front wheels of the cone assembly cannot effectively conform to the pipe wall, causing the cone assembly to form an angle with the pipeline axis. In such cases, the cone assembly of the internal pipeline welding machine must adjust its position and posture to follow the groove's posture, so that the welding torch in the welding unit 304 is aligned with the center of the weld seam. To address the above-mentioned technical problems in the prior art, this application provides an internal pipeline welding machine automatic alignment device and alignment method, aimed at improving the cone assembly's posture adjustment capabilities during forward and backward movements to locate the alignment region, while also taking into account operator safety, alignment quality, and equipment weight.

Specifically, the internal pipeline welding machine automatic alignment device and method provided in this application can be applied in internal pipeline welding scenarios for joining curved pipelines. The alignment device can flexibly adjust the posture of the cone assembly 301 and move with high adaptability inside the curved pipe. A sensor detection system provides feedback to the multi-degree-of-freedom adjustment mechanism 303 to achieve precise alignment. This embodiment uses a high-precision sensor detection system to collect pipeline profile data for automatic alignment. The high-precision and highly flexible six-degree-of-freedom motion platform allows the cone assembly 301 to adjust its position and posture freely within a certain range. A rotation- and scale-invariant image matching algorithm enables stable discrimination between positioning and alignment scenarios. High-efficiency, robust corner point estimation is achieved through corner detection in image space. The least-squares-based profile fitting method accurately determines the actual feature points of the groove. The designed product, which integrates the multi-sensor acquisition system and the cone assembly posture adjustment system, can be applied in curved pipe alignment welding operations.

The internal pipeline welding machine automatic alignment device includes: a cone assembly 301, sensors 4, a multi-degree-of-freedom adjustment mechanism 303, and a body mechanism 302. The cone assembly 301 includes a plurality of welding units 304 and tensioning devices 306. The sensors 4 consist of several laser vision sensors (e.g., stripe laser displacement sensors) mounted on the frame of the cone assembly 301. The multi-degree-of-freedom adjustment mechanism 303 is connected between the cone assembly 301 and the body mechanism 302 and consists of several electric cylinders. By controlling the length of each electric cylinder, the multi-degree-of-freedom adjustment mechanism 303 allows the cone assembly 301 to flexibly deflect and shift relative to the body mechanism. The body mechanism 302 includes a traveling device 308, a braking device 309, a flexible front wheel 3010, and other mechanisms. These components enable the internal pipeline welding machine to perform forward motion, reverse motion, and stop motion within a curved pipeline.

The internal pipeline welding machine automatic alignment method includes the following steps:

Step 1: Use several laser vision sensors (such as three stripe laser displacement sensors) to detect the pipeline profile data around the periphery of the internal pipeline welding machine's tensioning shoe 305. The pipeline profile data collected by each laser vision sensor is individually downsampled and converted into a binarized profile image. Each binarized profile image is then matched with a preset groove profile image.

To improve the speed of scenario classification based on the data, the pipeline profile data needs to be downsampled. At the same time, to prevent image distortion, the images should be proportionally scaled. The sensor data consists of coordinate values of the pipeline profile points; a direct mapping relationship is then established between the profile coordinates and the pixel coordinates. The pixels corresponding to the coordinate values are assigned a value of 1, while background pixels are assigned a value of 0, thereby generating a binarized profile image of the groove.

The binarized profile image and the preset groove profile image undergo translation (Δx,Δy), rotation Δα, and scaling λ transformation, (Δx,Δy) represents the translation in the horizontal and vertical coordinates, Δα is the rotation angle, and λ is the scaling factor. The coordinate transformation relationship is as follows:

m′[x,y]=t[Δ(x·cos Δα+γ·sin Δα)−Δx,λ(−x·sin Δα+y·cos Δα)−Δy]

Wherein m[x,y] is the profile image, m′[x,y] is a corresponding part of the profile image to the template (the preset groove profile image), and t[x,y] is the preset groove profile image, x denotes a horizontal axis, and y denotes a longitudinal axis. By applying the Fourier transform on both sides of the above equation, we obtain:

M′[u,v]=λ⁻²e^{-2πj(uΔx+vΔy)}T[λ⁻¹(u·cos Δα+v·sin Δα),λ⁻¹(−u·sin Δα+v·cos Δα)]

wherein M′[u,v] is the result of the Fourier transform of m[x,y]; [symbol] and [symbol] represent the horizontal and vertical coordinates, respectively, in the image coordinate system after the Fourier transform of the original image m′[x,y], that is, the pixel positions after the Fourier transform. These coordinates are used to express the frequency and wavefront direction information of the original image; e represents the natural constant; j is the imaginary unit; T represents the result of the Fourier transform of the preset groove profile image t.

Removing the translation information from the above equation and expressing it in the log-polar coordinate system, we get:

M[lgρ,α]=λ⁻²T[lgρ−lgλ,α−Δα].

M[lgρ,α] represents the result after removing the phase information e^{-2πj(uΔx+vΔy)} and performing a log-polar coordinate transformation. ρ represents the radius in the polar coordinate system, and α represents the polar angle in the log-polar coordinates of the image M[lgρ,α]. In this embodiment, α can be considered as the baseline for the image before rotation transformation, and α−Δα indicates that the image has undergone a baseline rotation of Δα.

By T[lgρ−lg λ, α−Δα], the rotation Δα and the scaling λ can be calculated through phase correlation. The image in the template is then transformed based on these parameters Δα and λ. Afterward, it is matched with the wheel profile image using image phase correlation again to calculate the translation (Δx;Δy). Based on the translation and rotation values, the multi-degree-of-freedom posture adjustment mechanism is adjusted so that when the groove profile image is positioned at the center of the entire image, the axis of the cone assembly 301 also remains close to the axis of the pipeline, thereby avoiding collisions with the pipe wall during the process of the cone assembly 301 exiting the pipe.

This process can occur not only before the alignment method but also during the alignment procedure, that is, after determining whether the pipe end has been detected and before the internal pipeline welding machine is stopped from axial movement by the drive mechanism. The translation and rotation values obtained through the above method can be used as coarse translation and coarse rotation values of the pipeline profile relative to the cone assembly 301. By performing posture adjustment before stopping the internal pipeline welding machine, the alignment can be made more accurate and efficient.

Specifically, the pipeline profile data collected by all the sensors is stitched and transformed into a unified coordinate system based on the sensor installation calibration parameters, thereby obtaining the overall pipeline profile data under the coordinate system of the cone assembly. Based on this overall pipeline profile data, the position and posture information of the current pipeline under the coordinate system of the cone assembly is determined. Here, the current pipeline refers to the one corresponding to the collected pipeline profile data. The posture adjustment mechanism of the cone assembly is then used to adjust the position and posture of the cone assembly 301 according to the pipeline position and posture information, so that the axis of the cone assembly 301 aligns with the axis of the current pipeline. The overall pipeline profile data mentioned above is the stitched result of the pipeline profile data collected by each sensor 4 and is used to describe the overall profile shape of the inner wall of the pipeline. Using the sensor installation calibration coefficients obtained through prior measurement, the pipeline profile data collected by each sensor 4 is stitched and transformed into the coordinate system of the cone assembly (i.e., the overall pipeline profile point cloud data).

The sensor installation calibration coefficient is a homogeneous transformation matrix composed of the designed installation dimensions of each structural component and the measured installation error of each sensor. By multiplying the profile data scanned by each sensor 4 with this homogeneous transformation matrix, the profile data of each sensor 4 can be transformed into the coordinate system of the cone assembly. The specific process is as follows:

Assuming that the pipeline profile data collected by one sensor 4 is A(xᵢ,yᵢ,0), based on the installation design dimensions and installation error, the obtained homogeneous transformation matrix is:

$${T}_{A} = [ \begin{matrix}Rot & p \\ 0 & 1\end{matrix} ] ,$$

where Rot represents the rotation transformation matrix, composed of the angle between the coordinate axes of the sensor coordinate system and the cone assembly coordinate system; p is a coordinate vector composed of the coordinates of the origin of the sensor coordinate system in the coordinate system of the cone assembly, indicating a translation transformation.

The stitched pipeline profile data is expressed as:

$$P ( {x}_{i} , {y}_{i} , {z}_{i} ) = [ \begin{matrix}A & B & C & …\end{matrix} ] \cdot [ \begin{matrix}{T}_{A} \\ {T}_{B} \\ {T}_{C} \\ ⋮\end{matrix} ] ,$$

wherein P(xᵢ,yᵢ,zᵢ) represents the overall pipeline profile data, A, B, C . . . denote the pipeline profile data collected by each sensor 4, and T_{A}, T_{B}, T_{C} . . . are the homogeneous transformation matrices corresponding to each sensor 4.

Step 2: Based on the profile image matching results, control the stop position of the internal pipeline welding machine's travelling device 308 so that the welding unit 304 in the cone assembly 301 steadily stops within the groove region 3012. FIG. 26 shows the stop position of the welding unit 304 in the groove region 3012. When the image matching indicates that the pipe end surface has been detected and the number of successful matches is greater than one, the position relationship between the sensors 4 and the plane where the pipe end surface is located is calculated to determine whether it meets the preset distance condition. When the condition is satisfied, the internal pipeline welding machine is commanded to stop, such that the welding unit 304 stops within the groove region 3012.

Step 3: Based on the stopped position of the internal pipeline welding machine, profile data at that moment is acquired using each sensor 4, and the binary down-sampled profile image (i.e., the image corresponding to the pipeline profile data) is used to perform corner detection, thereby obtaining rough coordinate values of the feature points in the profile image.

Stable rough coordinates of each feature point on the profile can be obtained through the corner detection algorithm. The corner detection results are shown in FIG. 25.

Using the rough coordinates of the feature points in the profile image as initial values, perform optimal fitting on the profile data to obtain the precise coordinates of the groove profile feature points (i.e., groove feature points).

Specifically, using the coordinates of the corner points as the initial values, the process of obtaining the groove feature points by performing a least squares-based fitting calculation on the pipeline profile data is as follows:

Use the corner coordinates as initial values to construct a mathematical model of the groove profile corresponding to the pipeline profile data, and the mathematical model y(x) of the groove profile can be represented as:

$$y ( x ) = a + {k}_{1} x + {\sum }_{j = 1}^{n - 1} {k}_{j + 1} ( x - {b}_{j} ) \cdot ε ( x - {b}_{j} ) ;$$

n represents the number of linear segments;
a represents the intercept of y(x);
kⱼ represents the slope difference between adjacent line segments, j=1, 2, . . . n−1;
bⱼ; represents the x-coordinate of the position where the feature point is located, j=1, 2, . . . n−1.
ε(x−bⱼ) is defined as: ε(x−bⱼ)=1 if x≥bⱼ, otherwise ε(x−bⱼ)=0;

By obtaining the rough coordinates of the characteristic points from the profile image, they are converted into â, \hat{b}ⱼ, \hat{k}ⱼ as the initial estimated values, with “\hat{ }” used to distinguish initial and final values from other characters.

Using the least squares optimization objective function to solve the mathematical model of the profile, the process of obtaining the groove feature points is as follows:

The groove profile mathematical model y(x) is a nonlinear function, and the following optimization function F(X) is established:

$$F ( X ) = \frac{1}{2} {\sum }_{i = 1}^{n} {( y ( x ) - {y}_{i} )}^{2} ;$$

By solving the minimum values of the nonlinear function, the model y(x) parameters a, bⱼ, and kⱼ can be obtained.

The fitting result (is shown in FIG. 29, where the points of slope change in the curve are used as the feature points of the groove and considered the characteristic points of the groove.

The precise feature points of the groove profile under the sensor coordinate system are then transformed and stitched into the cone assembly coordinate system to obtain the spatial coordinates of groove feature points.

Using the homogeneous transformation matrix measured and calculated from installation parameters, the coordinates of each sensor 4's groove feature points are transformed into the cone assembly coordinate system.

Using the spatial coordinates of these groove feature points, the position and posture of the current pipeline groove relative to the circular shape under the cone assembly coordinate system can be determined.

Let the grove feature points be denoted by Aᵢ(xᵢ,yᵢ,zᵢ), where i=3, i.e., when three groove feature points A1, A2, and A3 are obtained, the data parameters of the circular shape where the groove is located can be calculated using the formula below:
1. The normal vector of the groove circle: \vec{n}=\vec{a}×\vec{b}, where \vec{a}=(A₁−A₂), \vec{b}=(A₂−A₃);
2. The coordinates of the circle center:

$$\{ \begin{matrix}{x}_{0} = \frac{{x}_{1} + {x}_{2}}{2} + R {1}_{x} * t \\ {y}_{0} = \frac{{y}_{1} + {y}_{2}}{2} + R {1}_{y} * t \\ {z}_{0} = \frac{{z}_{1} + {z}_{2}}{2} + R {1}_{z} * t\end{matrix} , where \{ \begin{matrix}\vec{R} 1 = \vec{n} \times \vec{a} \\ \vec{R} 2 = \vec{n} \times \vec{b}\end{matrix} ,$$

$$t = \frac{R {2}_{x} ( {y}_{1} - {y}_{3} ) - R {2}_{y} ( {x}_{1} - {x}_{3} )}{2 ( R {1}_{x} R {2}_{y} - R {2}_{x} R {1}_{y} )} ;$$

In the above equation, the subscripts x, y, and z of Rᵢ indicate the coordinates along the respective coordinate axes.
3. The circle radius R:

R=∥o−A₁∥

Based on the plane of the pipe groove and the normal vector of the profile (i.e., the angular deviation relative to the cone assembly 301), as well as the center coordinates (i.e., the offset relative to the cone assembly 301), a multi-degree-of-freedom adjustment mechanism 303 (i.e., a six-degree-of-freedom motion platform) is used to align the welding torch of the welding unit 304 on the cone assembly 301 precisely with the center of the groove weld seam.

After the posture adjustment of the cone assembly 301 is completed, the tensioning shoe 305 in the rear tensioning mechanism on the cone assembly 301 extends and presses against the inner wall of the pipe. A new pipe to be aligned is installed, and the tensioning shoe 305 in the front tensioning mechanism on the cone assembly 301 extends to press against the inner wall of the pipe, thus completing the alignment.

This embodiment establishes a nonlinear optimization problem to solve for the groove model parameters, effectively suppressing random errors introduced during sensor measurements. At the same time, by using a groove mathematical model, the extraction accuracy of groove feature points can exceed the resolution of the stripe laser displacement sensor images, providing strong support for achieving a alignment accuracy of less than 0.2 mm in the internal pipeline welding machine.

The alignment device provided in this embodiment, in coordination with the sensors 4 and the multi-degree-of-freedom adjustment mechanism 303, enables detection of the groove posture and feedback to the adjustment mechanism 303. The multi-degree-of-freedom adjustment mechanism 303 performs forward and inverse kinematic calculations and controls the extension of the actuators to achieve flexible control of the cone assembly 301's position and posture inside the pipe, thus meeting the welding alignment requirements. This embodiment constructs a laser vision sensor measurement system to collect spatial position information of the target object during the internal pipeline welding alignment process. The image data processing unit calculates the pipe and groove position and posture, and the resulting position and posture information is fed back to the multi-degree-of-freedom adjustment mechanism 303 for real-time adjustment of the spatial position and posture of the cone assembly 301.

In the alignment method provided by this embodiment, a mathematical model of the groove is used to accurately describe the geometric shape of the pipe groove and the angular and offset deviation relative to the cone assembly 301. Moreover, by iteratively solving the numerical solutions of the groove or geometric shapes containing partial pipeline profile through the optimization, this alignment method can effectively suppress the random errors caused by environmental factors and manufacturing inaccuracies of the pipe and groove.

In the process of extracting the precise coordinates of profile vertices, the traditional Douglas-Peucker polygon fitting method determines certain special points by comparing the distance values between individual profile points and the profile itself, and uses these special points as polygon profile feature points. However, this method presents the following difficulties in practical application: on one hand, due to the reflective properties of light, when measuring the profile at the intersection angle of two straight lines, a “sharp” triangular shape cannot be presented, and as a result, the actual groove profile corners do not appear in the laser profile data; on the other hand, due to factors such as occlusion in the field of view of the laser sensor, blurry steep profile edges, and stray light interference, the profile data often contains abrupt changes. This embodiment adopts least squares fitting, which can effectively suppress abrupt changes in the profile data. Moreover, by introducing the least squares method in profile fitting, it can accurately estimate the actual groove feature points that do not exist in the laser profile data. In the profile fitting process of this embodiment, it is necessary to set initial iteration values for the feature points. By uniformly downsampling the groove profile data in the X and Y directions and transforming the profile data into image space, Harris corner detection is employed to obtain a coarse estimation of the coordinates of the profile feature points. In this way, while reducing the amount of data processing, stable estimated values for the groove feature points' coordinates can still be obtained. These estimated values are then substituted into the initial iteration values of the groove profile fitting so that the iterative result can converge to the true coordinate values of the groove feature joint points. This embodiment extracts the groove vertex, calculates the position and posture of the circle to which the groove belongs under the coordinate system of the cone assembly, and feeds the information back to the multi-degree-of-freedom adjustment mechanism 303 (six-degree-of-freedom motion platform) to adjust the posture of the cone assembly in real time, greatly increasing the flexibility of alignment.

The embodiment of this application provides an alignment device for the internal pipeline welding machine. The internal pipeline welding device with the alignment device includes sensors 4 mounted on the cone assembly 301 and a multi-degree-of-freedom adjustment mechanism 303 disposed between the cone assembly 301 and the body mechanism 302. The internal pipeline welding machine alignment device includes:
tensioning shoes 305 arranged circumferentially around the machine head;
sensors 4, configured to detect the pipeline profile data around the welding unit 304 of the internal pipeline welding machine and to determine, based on the profile data, whether the pipe end face has been detected;
a control system, configured to control the drive mechanism of the internal pipeline welding machine to stop the machine from moving along the axial direction of the pipe when the sensors 4 detecting the profile data and the plane of the pipe end face meet a preset distance;

The control system is also configured to compute the positional relationship between the sensors 4 and the pipe end face to obtain position and posture information. Based on the position and posture information, the system adjusts the multi-degree-of-freedom adjustment mechanism 303 between the cone assembly 301 and the machine body so that the cone assembly 301 of the internal pipeline welding machine is aligned precisely with the groove to be welded, and the internal pipeline welding machine is fixed relative to the pipeline.

Since the embodiments of the device part correspond to those of the method part, reference is made to the descriptions of the method embodiments, and they will not be repeated herein.

This application also provides a storage medium having stored thereon a computer program which, when executed, can implement the steps described in the above embodiments. The storage medium may include: USB flash drives, portable hard disks, read-only memory (ROM), random access memory (RAM), magnetic disks, optical discs, or various other media capable of storing program code.

This application further provides an internal pipeline welding machine, including a cone assembly 301, a body mechanism 302, sensors 4, a multi-degree-of-freedom adjustment mechanism 303, a memory, and a processor. The sensors 4 are disposed on the cone assembly 301. The multi-degree-of-freedom adjustment mechanism 303 is arranged between the cone assembly 301 and the body mechanism 302. The memory stores a computer program, and the processor executes the computer program stored in the memory to implement the steps provided in the above embodiments.

The above embodiments are described progressively, and each embodiment focuses on aspects different from other embodiments. The similar or identical parts across the embodiments may be referenced to one another. For the embodiments disclosing the device, since they correspond to the method embodiments, the descriptions are simplified, and related parts refer to the method descriptions.

The above is merely a preferred embodiment of the invention. It should be noted that the preferred embodiments should not be considered as limitations of the invention. The scope of protection of the invention should be defined by the claims. For those skilled in the art, various modifications and refinements can be made without departing from the spirit and scope of the invention, and these modifications and refinements should also be regarded as within the scope of the invention.

What is claimed is:

1. An internal pipeline welding machine, comprising a machine head, a machine body, and a first connecting mechanism; wherein
the machine head is provided with a first tensioning mechanism and a welding mechanism;
the machine body is provided with a traveling system for a movement inside a pipeline;
the machine head is connected to the machine body via the first connecting mechanism, and the first connecting mechanism has controllable degrees of freedom to enable a relative deflection between the machine head and the machine body.

2. The internal pipeline welding machine according to claim 1, wherein the first connecting mechanism comprises a static end and a movable end, the static end is connected to the machine body, and the movable end is connected to the machine head; a plurality of movable members are disposed in parallel between the static end and the movable end to enable a relative movement between the static end and the movable end.

3. The internal pipeline welding machine according to claim 2, wherein the plurality of movable members are linear telescopic components, with a first end of each of the linear telescopic components movably connected to the static end and a second end movably connected to the movable end.

4. The internal pipeline welding machine according to claim 1, wherein the first connecting mechanism is a parallel or serial motion mechanism, and the first connecting mechanism has two to six degrees of freedom.

5. The internal pipeline welding machine according to claim 1, further comprising sensors and a control system, wherein the sensors are disposed on the machine head for detecting the pipeline, the control system receives data detected and collected by the sensors, analyzes and processes the data to obtain control parameters, and the first connecting mechanism operates based on the control parameters to adjust a position and a posture of the machine head.

6. The internal pipeline welding machine according to claim 5, wherein the sensors are arranged circumferentially and spaced apart on the machine head, and a central axis of a circumference on which the sensors are located coincides with a central axis of the first tensioning mechanism.

7. The internal pipeline welding machine according to claim 5, wherein the sensors are stripe-type laser displacement sensors for detecting and collecting pipeline contour data.

8. The internal pipeline welding machine according to claim 5, wherein the control system comprises a coaxial unit, the coaxial unit is configured to analyze and process the data detected and collected by the sensors to obtain the control parameters for coaxial alignment, the first connecting mechanism operates based on the control parameters for coaxial alignment, such that a central axis of the welding mechanism on the machine head coincides with a central axis of the pipeline at a location of the welding mechanism.

9. The internal pipeline welding machine according to claim 5, wherein the control system comprises an alignment unit, the alignment unit analyzes and processes the data detected and collected by the sensors to obtain the control parameters for alignment, the first connecting mechanism operates based on the control parameters for alignment, so that the welding mechanism directly faces a center of a weld seam between two pipelines to be joined.

10. The internal pipeline welding machine according to claim 9, wherein the alignment unit comprises:
a scene determination module, configured to analyze and process the data detected and collected by the sensors to determine whether the sensors have detected a pipe end and is in an alignment scene;
a measurement module, wherein when in the alignment scene, the measurement module analyzes and processes the data detected and collected by the sensors to obtain a distance between the sensors and a plane where the pipe end is located;
a parking module, wherein the parking module issues a command to control the traveling system to park the machine body when the distance between the sensors and the plane where the pipe end is located reaches a traveling stop condition.
an alignment fine-adjustment module, configured to analyze and process the data detected and collected by the sensors while the machine body is in a stationary state to obtain the control parameters for fine adjustment, the first connecting mechanism operates based on the control parameters for fine adjustment, so that the welding mechanism directly faces the center of the weld seam between the two pipelines to be joined.

11. The internal pipeline welding machine according to claim 1, wherein the traveling system comprises a traveling mechanism, the traveling mechanism comprises a plurality of traveling wheel assemblies spaced circumferentially along the machine body, and the plurality of traveling wheel assemblies are connected to a second tensioning mechanism provided on the machine body.

12. The internal pipeline welding machine according to claim 11, wherein the plurality of traveling wheel assemblies are provided in pairs and are arranged on both sides of the machine body along a diameter of the machine body, the second tensioning mechanism comprises a tensioning hydraulic cylinder connected between the plurality of traveling wheel assemblies on both sides.

13. The internal pipeline welding machine according to claim 11, rein each of the plurality of traveling wheel assemblies is provided with a traveling motor, and the plurality of traveling wheel assemblies perform electronic differential control when navigating curved sections.

14. The internal pipeline welding machine according to claim 1, wherein the traveling system comprises a brake mechanism, the brake mechanism comprises a brake cylinder, a brake pad, and an elastic retaining member, the brake pad is driven by the brake cylinder to switch between a braking position and a released position, the brake pad is connected to the elastic retaining member for maintaining the brake pad in the braking position.

15. The internal pipeline welding machine according to claim 1, wherein the traveling system comprises a flexible wheel assembly, the flexible wheel assembly comprises a wheel, a wheel seat, and an elastic member, the wheel is installed on the wheel seat, the wheel seat is hinged to the machine body, a rotation plane of the wheel seat is aligned with a radial direction of the machine body, and the wheel seat is connected to the machine body via the elastic member.

16. The internal pipeline welding machine according to claim 15, wherein the flexible wheel assembly further comprises an angle adjustment motor provided on the wheel seat and connected to the wheel, and the angle adjustment motor is configured to adjust a traveling direction of the wheel.

17. The internal pipeline welding machine according to claim 1, further comprising a battery unit, wherein the battery unit supplies power to the first tensioning mechanism, the welding mechanism, the traveling system, and the first connecting mechanism.

18. The internal pipeline welding machine according to claim 1, wherein the machine body is divided into a plurality of segments along an axial direction of the pipeline, with adjacent segments connected by a second connecting mechanism, wherein the second connecting mechanism is a deflectable connection mechanism.

19. The internal pipeline welding machine according to claim 18, wherein the second connecting mechanism comprises a first end, a second end, a universal joint, and flexible connecting components, wherein the universal joint and the flexible connecting components are connected between the first end and the second end, the flexible connecting components is distributed circumferentially around the universal joint, the first end is connected to a preceding segment, and the second end is connected to a subsequent segment.
